(19) United States
(12) Patent Application Publication
(10) Pub. No.: US 2026/0365132 A1
(43) Pub. Date: Nov. 19, 2026

(54) COMPONENT FOR VEHICLE INTERIOR

(71) Applicant: Yanfeng International Automotive Technology Co. Ltd., Novi, MI (US)

(72) Inventor: John David, Birmingham, MI (US)

(21) Appl. No.: 19/731,830

(22) Filed: Jul. 6, 2026

Related U.S. Application Data
(63) Continuation of application No. PCT/US2025/012997, filed on Jan. 24, 2025.
(60) Provisional application No. 63/624,944, filed on Jan. 25, 2024.
(60) Provisional application No. 63/566,264, filed on Mar. 16, 2024.

(51) Int. Cl. B60R 21/201; B60R 21/231; B60R 21/2342

(52) U.S. Cl. CPC B60R 21/201; B60R 21/23138; B60R 21/2342

(57) ABSTRACT

A component configured to facilitate deployment of an airbag in a vehicle interior is disclosed. The component comprises a set of assemblies/wrappers configured to contain the airbag; each wrapper comprises a strip wrapped around the airbag with a fold and flap and tab; the wrapper is configured to provide selectable mounting positions and selectable trajectories of deployment for the airbag. The wrapper comprises a stitch and tab at the flap and fold to form a shape around the airbag and to provide selectable positions to retain the airbag and to direct deployment of the airbag. Each assembly is configured to be retained to the vehicle frame; each assembly may provide a holder assembly for the wrapper. The component may be installed in a trim panel in the vehicle interior; the seam in the strip is configured to form an opening in the trim panel during deployment of the airbag.

### CROSS-REFERENCE TO RELATED APPLICATIONS

The present application is a continuation of PCT/International Patent Application No. PCT/US2025/012997 titled “COMPONENT FOR VEHICLE INTERIOR” filed Jan. 24, 2025, which claims priority to U.S. Provisional Patent Application No. 63/566,264 titled “COMPONENT FOR VEHICLE INTERIOR” filed Mar. 16, 2024 and U.S. Provisional Patent Application No. 63/624,944 titled “COMPONENT FOR VEHICLE INTERIOR” filed Jan. 25, 2024.

The present application claims priority to and incorporates by reference in full the following patent applications: (a) U.S. Provisional Patent Application No. 63/624,944 titled “COMPONENT FOR VEHICLE INTERIOR” filed Jan. 25, 2024; (b) U.S. Provisional Patent Application No. 63/566,264 titled “COMPONENT FOR VEHICLE INTERIOR” filed Mar. 16, 2024; and (c) PCT/International Patent Application No. PCT/US2025/012997 titled “COMPONENT FOR VEHICLE INTERIOR” filed Jan. 24, 2025.

### FIELD

The present invention relates to a component for a vehicle interior.

### BACKGROUND

It is known to provide a component for a vehicle interior configured to facilitate deployment of an airbag from an airbag assembly into the vehicle interior.

It would be advantageous to provide an improved component to facilitate deployment of an airbag from an airbag assembly into the vehicle interior comprising a package assembly configured to mount/retain the airbag.

It would be advantageous to provide an improved component to facilitate deployment of an airbag from an airbag assembly into the vehicle interior comprising a wrapper/package assembly configured to mount/retain the airbag in multiple positions.

It would be advantageous to provide an improved component to facilitate deployment of an airbag from an airbag assembly into the vehicle interior comprising a wrapper/package assembly configured to mount/retain the airbag in multiple positions to facilitate installation of the airbag assembly in the vehicle interior.

It would be advantageous to provide an improved component to facilitate deployment of an airbag from an airbag assembly into the vehicle interior comprising a wrapper/package assembly configured to mount/retain the airbag in multiple positions to facilitate direction of routing of deployment of the airbag into the vehicle interior.

### SUMMARY

The present invention relates to a component for a vehicle interior comprising a vehicle frame configured to facilitate deployment of an airbag from an airbag module into a vehicle interior comprising a set of package assemblies configured to contain the airbag; each assembly of the set of package assemblies may comprise a wrapper configured to contain the airbag; each wrapper may comprise a strip; each strip may be configured to be wrapped around the airbag; each strip is configured to provide a fold and a flap; each strip may comprise a seam configured to form an opening for deployment of the airbag; each strip is closed to retain the airbag; each strip is configured to provide the fold at a location on the strip to provide a position for retaining the airbag; the location for providing the fold may comprise a plurality of selectable locations; the position for retaining the airbag may comprise a plurality of selectable positions; each assembly is configured to retain the airbag in the position to direct deployment of the airbag. Each wrapper may comprise the strip and a tab; each assembly is configured to be retained to the vehicle frame by the tab to direct the trajectory of deployment of the airbag during deployment of the airbag. The component may be configured to be installed in a trim panel in the vehicle interior; each assembly is configured to retain the airbag to be opened at the seam in the strip to direct deployment of the airbag to form an opening in the trim panel during deployment of the airbag. The airbag may be rolled within the strip and secured within the strip of the wrapper of the set of package assemblies. The strip may be fastened adjacent to the fold to retain the airbag and/or the strip is stitched adjacent to the fold to retain the airbag; the strip may be configured to be fixed to provide a form for the wrapper when folded at the fold and to provide a flap to be retained at the fold by a stitch at a location; the flap of the strip provides a mounting area for the wrapper; the wrapper may be configured to provide selectable mounting positions for the airbag and/or to provide selectable trajectories of deployment of the airbag; a stitch on the strip may comprise an upper stitch to provide a form for the wrapper and a lower stitch to facilitate routing for trajectory of deployment of the airbag; fastening on the strip may comprise an upper fastening to provide a form for the wrapper and a lower fastening to facilitate routing for trajectory of airbag deployment. The wrapper may comprise a package wrapper; the package wrapper may be stitched to a cushion of the airbag and stitched to enclose the cushion of the airbag within the strip of the package wrapper; the package wrapper may be formed by stitching the tab at the flap and the fold to close the strip into a form having a shape around the airbag. Slits may be provided on the strip to provide the seam providing a breakout location for direction of deployment for the airbag. The seam may comprise a weakened area configured to form a tear seam for an opening for deployment of the airbag. The strip may comprise a polypropylene material configured so that during deployment of the airbag the strip will break open to facilitate deployment of the airbag and the tab may be retained intact. A fixing stitch for the strip may be attached at a fixed point on the strip defined by the fold; the fixing stitch establishes the position of the airbag. The wrapper may be configured to retain the airbag in a first position to be opened at the seam in the strip and to be retained to the vehicle frame by the tab to direct a first trajectory of deployment of the airbag; the wrapper may be configured to retain the airbag in a second position to be opened at the seam in the strip and to be retained to the vehicle frame by the tab to direct a second trajectory of deployment of the airbag.

The present invention relates to a component for a vehicle interior comprising a vehicle frame configured to facilitate deployment of an airbag from an airbag module comprising a set of package wrappers configured to be attached to the vehicle frame; a wrapper of the set of package wrappers is configured to contain the airbag; the wrapper may comprise a strip and a tab; the strip is configured to be wrapped around the airbag; the strip is configured to provide a fold; the strip is configured to provide the fold at a first location on the strip to provide a first form comprising a first position for retaining the airbag; the strip is configured to provide the fold at a second location on the strip to provide a second form comprising a second position for retaining the airbag; the strip is closed to retain the airbag; the strip may comprise a seam configured to form a tear line for deployment of the airbag; the wrapper is configured to retain the airbag in the first position to be opened at the seam in the strip and to be retained to the vehicle frame by the tab to direct a first trajectory of deployment of the airbag; the wrapper is configured to retain the airbag in the second position to be opened at the seam in the strip and to be retained to the vehicle frame by the tab to direct a second trajectory of deployment of the airbag; the set of package wrappers may be configured to be adjustable by location of a stitch and/or the fold to provide multiple mounting positions for each wrapper. A set of package assemblies may comprise the set of package wrappers; each assembly of the set of package assemblies may comprise a holder assembly for each wrapper of the set of package wrappers; each holder assembly may be configured to be adjustable by location of a stitch and/or the fold to provide multiple selectable mounting positions for each wrapper within a range; the holder assembly may be configured to be attached to the vehicle frame by a fastener at the tab and/or a fastener at the flap of the strip. Fastening on the strip may comprise an upper fastening to provide a form for the wrapper and a lower fastening to facilitate routing for trajectory of airbag deployment.

The present invention relates to a component for a vehicle interior configured to facilitate deployment of an airbag from an airbag module into a vehicle interior comprising a set of holder assemblies configured to contain the airbag; each holder assembly may comprise a wrapper configured to contain the airbag; the wrapper may comprise a strip and a tab; the strip may be configured to be wrapped around the airbag; the strip may be configured to provide a fold and a flap; the strip may be configured to provide the fold at a first location on the strip to provide a first position for retaining the airbag; the strip may be configured to provide the fold at a second location on the strip to provide a second position for retaining the airbag; the strip may be closed to retain the airbag. The airbag may be wrapped into the form of the wrapper. Each holder assembly may comprise a package wrapper assembly and/or a wrapper package assembly and/or a package assembly and/or a holder assembly and/or a holder and/or a wrapper assembly and/or a wrapper and/or a package wrapper. Each assembly may be configured to be retained to the vehicle frame to direct the trajectory of deployment of the airbag.

The present invention relates to a component for a vehicle interior comprising vehicle frame configured to facilitate deployment of an airbag from an airbag module into a vehicle interior comprising a set of package assemblies configured to contain the airbag; each assembly may comprise a wrapper configured to contain the airbag; each wrapper may comprise a strip and a tab; ach strip may be configured to be wrapped around the airbag; each strip may be configured to provide a fold and a flap; each strip may comprise a seam configured to form an opening for deployment of the airbag; each strip may be closed to retain the airbag; each strip may be configured to provide the fold at a location on the strip to provide a position for retaining the airbag; the location for providing the fold may comprise a plurality of selectable locations; the position for retaining the airbag may comprise a plurality of selectable positions; each assembly may be configured to retain the airbag in the position to be opened at the seam in the strip and to be retained to the vehicle frame by the tab to direct a trajectory of deployment of the airbag to form a door providing an opening in a trim panel during deployment of the airbag.

The present invention relates to a component for a vehicle interior comprising a vehicle frame configured to facilitate deployment of an airbag from an airbag module comprising a set of airbag package wrappers configured to be attached to the vehicle frame; a wrapper of the set of airbag package wrappers may be configured to contain the airbag; the wrapper may comprise a strip and a tab; the strip may be configured to be wrapped around the airbag; the strip may be configured to provide a fold; the strip may be configured to provide the fold at a first location on the strip to provide a first form comprising a first position for retaining the airbag; the strip may be configured to provide the fold at a second location on the strip to provide a second form comprising a second position for retaining the airbag; the strip may be closed to retain the airbag; the strip may comprise a seam configured to form a tear line for deployment of the airbag; the wrapper may be configured to retain the airbag in the first position to be opened at the seam in the strip and to be retained to the vehicle frame by the tab to direct a first trajectory of deployment of the airbag; the wrapper may be configured to retain the airbag in the second position to be opened at the seam in the strip and to be retained to the vehicle frame by the tab to direct a second trajectory of deployment of the airbag. A wrapper of the set of airbag package wrappers may be configured to contain the airbag; the airbag may be rolled within the strip and secured within the strip; the strip may be fastened and/or stitched adjacent to the fold to retain the airbag.

The present invention relates to a component for a vehicle interior configured to facilitate deployment of an airbag from an airbag module into a vehicle interior comprising a set of holder assemblies configured to contain the airbag; each holder assembly may comprise a wrapper configured to contain the airbag; the wrapper may comprise a strip and a tab; the strip may be configured to be wrapped around the airbag; the strip may be configured to provide a fold and a flap; the strip may be configured to provide the fold at a first location on the strip to provide a first position for retaining the airbag; the strip may be configured to provide the fold at a second location on the strip to provide a second position for retaining the airbag; the strip may be closed to retain the airbag; the holder assembly may comprise a package wrapper assembly and/or a wrapper package assembly and/or a package assembly and/or a holder assembly and/or a holder and/or a wrapper assembly and/or a wrapper and/or a package wrapper; the strip may be configured to provide the fold at the first location on the strip to provide a first form comprising the first position for retaining the airbag; the strip may be configured to provide the fold at the second location on the strip to provide a second form comprising the second position for retaining the airbag; the wrapper may be configured to retain the airbag in the first position to be opened at a seam in the strip and to be retained to the vehicle frame by the tab to direct a first trajectory of deployment of the airbag; the wrapper may be configured to retain the airbag in the second position to be opened at a seam in the strip and to be retained to the vehicle frame by the tab to direct a second trajectory of deployment of the airbag. The strip may be fixed and/or fastened to retain the airbag; the strip may be sealed and/or closed to retain the airbag; the strip may be closed by stitching to retain the airbag; the strip may be fixed by stitching to retain the airbag; the strip may be closed and fastened adjacent to the fold to retain the airbag; the strip may be secured by thread to retain the airbag; the strip may be sewn to retain the airbag; the strip may be stitched to retain the airbag; the strip may comprise a weakening line to facilitate tearing of the strip to facilitate deployment of the airbag. The tab may be secured on the strip and/or within the strip and/or to the strip; the tab may be stitched on the strip; the tab may be adhered to the strip; the tab may be secured to the strip adjacent to the fold of the strip; the tab may be secured on the strip and the airbag may be wrapped within the strip and secured within the strip. The airbag may be secured to the strip; the airbag may be rolled within the strip and secured within the strip; the airbag may be wrapped within the strip and secured within the strip; the airbag may comprise a generally cylindrical shape; the airbag may be rolled into a generally cylindrical shape; the strip may be configured to provide the fold at a third location on the strip to provide a third position for retaining the airbag. The holder assembly may be configured to be mounted to a vehicle frame in the vehicle interior; the holder assembly may be configured to form a tube-shaped holder. The vehicle interior may comprise a trim panel; the set of holder assemblies may be configured to be installed behind the trim panel. The vehicle interior may comprise a vehicle frame behind the trim panel. Each holder assembly of the set of holder assemblies may be configured to be attached to the vehicle frame behind the trim panel; each holder assembly of the set of holder assemblies may be configured to be attached to the vehicle frame by a set of fasteners; each holder assembly of the set of holder assemblies may be configured to be attached to the vehicle frame by a fastener at the tab and a fastener at the flap of the strip. Each fastener may comprise a pin or a bolt or a rivet or a plastic fastener. Each holder may be configured to direct formation of an opening for deployment of the airbag; each holder may be configured to direct formation of an opening in a trim panel for deployment of the airbag; each holder may be configured to retain the airbag in a position to direct deployment of the airbag; each holder may be configured to retain the airbag in a position to direct trajectory of deployment of the airbag; each holder may be configured to retain the airbag in a position to direct formation of an opening in the trim panel for deployment of the airbag. The trim panel may be configured to form an opening and/or a door for deployment of the airbag; the trim panel may comprise a seam configured to form a door for deployment of the airbag; the trim panel may be configured to provide a hinge for the door for deployment of the airbag; the trim panel may be configured to provide a tear line for the door for deployment of the airbag; the trim panel may be configured to provide a separation for the door for deployment of the airbag; the trim panel may be configured to provide an opening at the door for deployment of the airbag. Each holder assembly may be configured to provide a tear line at a seam in the strip for deployment of the airbag. The seam in the strip may comprise a perforation and/or a perforation line and/or a perforation and/or a slit and/or holes and/or cuts; the seam may comprise a perforation line in the strip wrapped around the airbag. Each holder assembly may comprise a seam for the tear line in the strip for deployment of the airbag. Each holder may be configured to be separated at the seam in the strip during deployment of the airbag and/or to be opened at the seam in the strip during deployment of the airbag and/or to be retained by the tab during deployment of the airbag and/or to be retained to the vehicle frame by the tab during deployment of the airbag and/or to be retained to the vehicle frame by the tab after deployment of the airbag; each holder may be configured to retain the airbag in a position to be opened at the seam in the strip and to be retained to the vehicle frame by the tab during deployment of the airbag; each holder may be configured to retain the airbag in a position to be opened at the seam in the strip and to be retained to the vehicle frame by the tab to route trajectory of deployment of the airbag; each holder may be configured to retain the airbag in a first position to be opened at the seam in the strip and to be retained to the vehicle frame by the tab to direct a first trajectory of deployment of the airbag; each holder may be configured to retain the airbag in a second position to be opened at the seam in the strip and to be retained to the vehicle frame by the tab to direct a second trajectory of deployment of the airbag; each holder may be configured to retain the airbag in a third position to be opened at the seam in the strip and to be retained to the vehicle frame by the tab to direct a third trajectory of deployment of the airbag; each holder may be configured to retain the airbag in a position to be opened at the seam in the strip and to be retained to the vehicle frame by the tab to direct a trajectory of deployment of the airbag to form a door providing an opening in a trim panel during deployment of the airbag; the position may comprise a plurality of selectable positions. The holder assembly may comprise a wrapper package assembly configured to retain an airbag in multiple positions; the holder assembly may comprise a wrapper package assembly configured to be adjustable by location of a stitch and/or a fold to provide multiple mounting positions within a range. The wrapper package assembly may be configured to retain and/or contain the airbag. The strip may be configured to be fixed to provide a form for the package wrapper when folded at the fold to provide the flap to be retained at the fold by a stitch at a location. The form may comprise a first form when the stitch is at a first location and a second form when the stitch is at a second location; the form may comprise a third form when the stitch is at a third location and a fourth form when the stitch is at a fourth location; the airbag may be wrapped into the form of the package wrapper to provide variable mounting positions for the airbag; the airbag may be wrapped into the form of the package wrapper to provide variable trajectories of deployment of the airbag. The strip may comprise a polypropylene material; the strip may comprise a die cut strip; the strip may comprise a sheet-formed strip configured to provide a plurality of mounting configurations in the vehicle interior. The package wrapper may comprise a base provided by the strip wrapped around the airbag to be mounted to a vehicle frame by fasteners. The fold and/or a fixing stitch for the strip can be provided at a first location and/or a second location and/or a third location; a fixing stitch for the strip can be provided at a first location and/or a second location and/or a third location; a fixing stitch for the strip can be attached at a fixed point on the strip defined by the fold; the stitch for the strip establishes the position of the airbag; the flap of the strip provides a mounting area for the package wrapper. An airbag assembly comprising the airbag may be configured to be contained by the strip wrapped around the airbag; the package wrapper may be formed by the strip wrapped around the airbag; the strip may comprise a plastic strip and/or an extruded strip and/or a flat-formed sheet and/or a molded sheet and or a sheet-formed cut strip; the strip may comprise a sheet-formed die-cut strip; the strip may comprise an aperture; the strip may comprise a weakened area configured to form a tear seam for an opening for deployment of the airbag. The airbag may comprise a rolled cushion pack; the package wrapper may be wrapped around the rolled cushion pack of the airbag. The component may comprise a plurality of package wrappers. The tab may comprise a fabric tab. Fastening on the strip may comprise an upper fastening to provide a form for the wrapper and a lower fastening to facilitate routing for trajectory of airbag deployment. A stitch on the strip may comprise an upper stitch to provide a form for the wrapper and a lower stitch to facilitate routing for trajectory of airbag deployment; the package wrapper may be stitched to the cushion of the airbag and stitched to enclose the cushion of the airbag within the strip of the package wrapper; the location of the stitch may determine the position of the airbag; the package wrapper may be formed by stitching the tab at the flap and the fold to close the strip into a form having a shape around the airbag. Slits may be provided on the strip to provide a seam providing a breakout location and direction of deployment for the airbag. Stitches for the package wrapper may be applied by needling through the strip. The strip may comprise a polypropylene material configured so that during deployment of the airbag the strip will break open to facilitate deployment of the airbag and the tab is retained intact.

The present invention relates to a component for a vehicle interior comprising a vehicle frame configured to facilitate deployment of an airbag from an airbag module into a vehicle interior comprising a set of package assemblies configured to contain the airbag; each assembly may comprise a wrapper configured to contain the airbag; each wrapper may comprise a strip and a tab; each strip may be configured to be wrapped around the airbag; each strip may be configured to provide a fold and a flap; each strip may comprise a seam configured to form an opening for deployment of the airbag; each strip may be closed to retain the airbag; each strip may be configured to provide the fold at a location on the strip to provide a position for retaining the airbag; the location for providing the fold may comprise a plurality of selectable locations; the position for retaining the airbag may comprise a plurality of selectable positions; each assembly may be configured to retain the airbag in the position to be opened at the seam in the strip and to be retained to the vehicle frame by the tab to direct a trajectory of deployment of the airbag to form a door providing an opening in a trim panel during deployment of the airbag. The position for retaining the airbag may comprise the plurality of selectable positions within a range. Each strip may be configured to provide the fold at a first location on the strip to provide a first position for retaining the airbag; each strip may be configured to provide the fold at a second location on the strip to provide a second position for retaining the airbag; the strip may be configured to provide the fold at the first location on the strip to provide a first form comprising the first position for retaining the airbag; the strip may be configured to provide the fold at the second location on the strip to provide a second form comprising the second position for retaining the airbag; the position may comprise a plurality of positions configured to be selected by location of the fold; the wrapper may be configured to retain the airbag in the first position to be opened at a seam in the strip and to be retained to the vehicle frame by the tab to direct a first trajectory of deployment of the airbag; the wrapper may be configured to retain the airbag in the second position to be opened at a seam in the strip and to be retained to the vehicle frame by the tab to direct a second trajectory of deployment of the airbag; the strip may be fixed and/or sealed and/or closed by stitching to retain the airbag.

The present invention relates to a component for a vehicle interior configured for deployment of an airbag into the vehicle interior comprising an airbag cushion assembly comprising a cushion and a tab and a package wrapper for the cushion; the package wrapper may comprise a wrap configured to enclose the airbag cushion; the package wrapper may comprise an extension extending from the wrap; the tab may be sewn to the cushion; the extension may comprise a flap; the wrap may comprise a strip; the tab may be sewn to the package wrapper; the tab may be sewn to the cushion and the package wrapper; the tab may comprise a mounting tab; the tab may be configured to couple the cushion to a frame of the vehicle; the package wrapper may comprise a unitary construction. The wrap of the package wrapper may extend around the cushion; the package wrapper may be coupled with the cushion; the wrap and the extension may be sewn to the cushion. The package wrapper may be folded to provide the wrap and the extension; the package wrapper may comprise a fold; the package wrapper may be sewn to the cushion at the fold and/or sewn to the tab at the fold. The component may comprise a rivet comprising a through hole configured to facilitate coupling of the cushion to a frame of the vehicle.

The present invention relates to a method of manufacturing a component for a vehicle interior configured for deployment of an airbag into the vehicle interior comprising the steps of providing a package wrapper, providing a cushion for the airbag, folding the package wrapper, coupling the package wrapper with the cushion, rolling the cushion, and closing the package wrapper around the cushion. The step of folding the package wrapper may comprise providing a wrap and an extension. The step of coupling the package wrapper with the cushion may comprise sewing the package wrapper to the cushion at the fold.

The present invention relates to a component for a vehicle interior configured to facilitate deployment of an airbag from an airbag module; the vehicle interior component may comprise a set of airbag package wrappers configured to be attached to the vehicle frame; each wrapper may be configured to contain the airbag; the wrapper may comprise a strip and a tab; the strip may be configured to be wrapped around the airbag; the strip may be configured to provide a fold and a tab secured to the strip; the strip may be configured to provide the fold at a first location on the strip to provide a first form comprising a first position for retaining the airbag; the strip may be configured to provide the fold at a second location on the strip to provide a second form comprising a second position for retaining the airbag; the strip may be closed to retain the airbag; the strip may comprise a seam configured to form a tear line for deployment of the airbag; the wrapper may be configured to retain the airbag in the first position to be opened at the seam in the strip and to be retained to the vehicle frame by the tab to direct a first trajectory of deployment of the airbag; the wrapper may be configured to retain the airbag in the second position to be opened at the seam in the strip and to be retained to the vehicle frame by the tab to direct a second trajectory of deployment of the airbag; the airbag may be rolled within the strip and secured within the strip; the strip may be closed adjacent to the fold to retain the airbag; the strip may be fixed adjacent to the fold to retain the airbag; the strip may be fixed by stitching to retain the airbag.

The present invention also relates to a component for a vehicle interior configured to facilitate deployment of an airbag from an airbag module into a vehicle interior; the vehicle interior component may comprise a set of holder assemblies configured to contain the airbag; each holder assembly may comprise a wrapper configured to contain the airbag; the wrapper may comprise a strip and a tab; the strip may be configured to be wrapped around the airbag; the strip may be configured to provide a fold and a tab; the strip may be configured to provide the fold at a first location on the strip to provide a first position for retaining the airbag; the strip may be configured to provide the fold at a second location on the strip to provide a second position for retaining the airbag; the strip may be closed to retain the airbag; the strip may be configured to provide the fold at the first location on the strip to provide a first form comprising the first position for retaining the airbag; the strip may be configured to provide the fold at the second location on the strip to provide a second form comprising the second position for retaining the airbag. The wrapper may be configured to retain the airbag in the first position to be opened at a seam in the strip and to be retained to the vehicle frame by the tab to direct a first trajectory of deployment of the airbag; the wrapper may be configured to retain the airbag in the second position to be opened at a seam in the strip and to be retained to the vehicle frame by the tab to direct a second trajectory of deployment of the airbag. The strip may be fixed to retain the airbag; the strip may be sealed to retain the airbag; the strip may be closed by stitching to retain the airbag; the strip may be fixed by stitching to retain the airbag; the strip may be closed adjacent to the fold to retain the airbag; the strip may be fixed adjacent to the fold to retain the airbag; the strip may be secured by thread to retain the airbag; the strip may be sewn to retain the airbag; the strip may be stitched to retain the airbag; the strip may comprise a weakening line to facilitate tearing of the strip to facilitate deployment of the airbag. The tab may be secured to the strip; the tab may be secured on the strip; the tab may be secured within the strip; the tab may be fastened to the strip; the tab may be stitched on the strip; the tab may be adhered to the strip; the tab may be secured to the strip adjacent to the fold of the strip; the fold of the strip may be made adjacent to where the tab may be secured to the strip; the tab may be secured on the strip and the airbag may be wrapped within the strip and secured within the strip. The airbag may be secured to the strip; the airbag may be secured within the strip; the airbag may be rolled within the strip and secured within the strip; the airbag may be wrapped within the strip and secured within the strip; the airbag may comprise a generally cylindrical shape; the airbag may comprise a generally tubular shape; the airbag may be rolled into a generally tubular shape; the airbag may be rolled into a generally cylindrical shape. The strip may be configured to provide the fold at a third location on the strip to provide a third position for retaining the airbag. The holder assembly may be configured to be mounted to a vehicle frame; the holder assembly may be configured to be mounted to a vehicle frame in the vehicle interior; the holder assembly may be configured to form a tube-shaped holder; the holder assembly may be configured to form a tube-shaped holder when the strip is folded to provide the fold and fixed to provide the flap. The vehicle interior may comprise a trim panel; a set of holder assemblies may be configured to be installed behind the trim panel; the vehicle interior may comprise a vehicle frame behind the trim panel; a set of holder assemblies may be configured to be installed to the vehicle frame; the set of holder assemblies may be configured to be installed to the vehicle frame behind the trim panel; the set of holder assemblies may be configured to be attached to the vehicle frame behind the trim panel; each holder assembly of the set of holder assemblies may be configured to be attached to the vehicle frame behind the trim panel; each holder assembly of the set of holder assemblies may be configured to be attached to the vehicle frame by a set of fasteners; each holder assembly of the set of holder assemblies may be configured to be attached to the vehicle frame by a pair of fasteners; each holder assembly of the set of holder assemblies may be configured to be attached to the vehicle frame by a fastener at the tab; each holder assembly of the set of holder assemblies may be configured to be attached to the vehicle frame by a fastener through an aperture at the tab; each holder assembly of the set of holder assemblies may be configured to be attached to the vehicle frame by a rivet at the tab; each holder assembly of the set of holder assemblies may be configured to be attached to the vehicle frame by a fastener at the flap of the strip; each holder assembly of the set of holder assemblies may be configured to be attached to the vehicle frame by a fastener through an aperture at the flap of the strip; each holder assembly of the set of holder assemblies may be configured to be attached to the vehicle frame by a bolt at the flap of the strip; each holder assembly of the set of holder assemblies may be configured to be attached to the vehicle frame by an expansion bolt at the flap of the strip; each holder assembly of the set of holder assemblies may be configured to be attached to the vehicle frame by a fastener at the tab and a fastener at the flap of the strip; each fastener may comprise a pin or a bolt or a rivet or a plastic fastener; each holder may be configured to direct formation of an opening for deployment of the airbag; each holder may be configured to direct formation of an opening in the trim panel for deployment of the airbag; each holder may be configured to retain the airbag in a position to direct deployment of the airbag; each holder may be configured to retain the airbag in a position to direct trajectory of deployment of the airbag; each holder may be configured to retain the airbag in a position to direct formation of an opening in the trim panel for deployment of the airbag. The trim panel may be configured to form an opening for deployment of the airbag; the trim panel may be configured to form a door for deployment of the airbag; the trim panel may comprise a seam configured to form a door for deployment of the airbag; the trim panel may be configured to provide a hinge for the door for deployment of the airbag; the trim panel may be configured to provide a tear line for the door for deployment of the airbag; the trim panel may be configured to provide a separation for the door for deployment of the airbag; the trim panel may be configured to provide an opening at the door for deployment of the airbag. Each holder assembly may be configured to provide a seam for deployment of the airbag; each holder assembly may be configured to provide a tear line for deployment of the airbag; each holder assembly may be configured to provide a tear line at a seam in the strip for deployment of the airbag; the seam may comprise a perforation; the seam may comprise a perforation line; the seam may comprise a perforation in the strip; the seam may comprise a line of perforations in the strip; the seam may comprise a perforation line in the strip wrapped around the airbag; each holder assembly may comprise a seam for the tear line in the strip for deployment of the airbag; each holder may be separated at the seam in the strip during deployment of the airbag; each holder may be opened at the seam in the strip during deployment of the airbag; each holder may be retained by the tab during deployment of the airbag; each holder may be retained to the vehicle frame by the tab during deployment of the airbag; each holder may be retained to the vehicle frame by the tab after deployment of the airbag; each holder may be opened at the seam in the strip and retained to the vehicle frame by the tab during deployment of the airbag; each holder may be configured to retain the airbag in a position to be opened at the seam in the strip and to be retained to the vehicle frame by the tab during deployment of the airbag; each holder may be configured to retain the airbag in a position to be opened at the seam in the strip and to be retained to the vehicle frame by the tab to direct trajectory of deployment of the airbag; each holder may be configured to retain the airbag in a first position to be opened at the seam in the strip and to be retained to the vehicle frame by the tab to direct a first trajectory of deployment of the airbag; each holder may be configured to retain the airbag in a second position to be opened at the seam in the strip and to be retained to the vehicle frame by the tab to direct a second trajectory of deployment of the airbag; each holder may be configured to retain the airbag in a third position to be opened at the seam in the strip and to be retained to the vehicle frame by the tab to direct a third trajectory of deployment of the airbag; each holder may be configured to retain the airbag in a position to be opened at the seam in the strip and to be retained to the vehicle frame by the tab to direct a trajectory of deployment of the airbag to form a door providing an opening in a trim panel during deployment of the airbag; the position may comprise a plurality of selectable positions; the holder assembly may comprise a package assembly; the holder assembly may comprise a wrapper package assembly; the holder assembly may comprise a wrapper package assembly configured to retain an airbag in multiple positions; the holder assembly may comprise a wrapper package assembly configured to be adjustable by location of a stitch and/or a fold to provide multiple mounting positions within a range; the wrapper package assembly may be configured to retain and/or contain the airbag; the holder assembly may comprise a package wrapper configured to contain the airbag and to be mounted to a vehicle frame; the holder assembly may comprise a package wrapper. The strip may be configured to provide a form when folded at the fold to provide the flap to be retained at the fold by a stitch; the strip may be configured to be fixed to provide a form for the package wrapper when folded at the fold to provide the flap to be retained at the fold by a stitch at a location; the form may comprise a first form when the stitch is at a first location and a second form when the stitch is at a second location; the form may comprise a third form when the stitch is at a third location and a fourth form when the stitch is at a fourth location. The airbag may be wrapped into the form of the package wrapper; the airbag may be wrapped into the form of the package wrapper to provide variable mounting positions for the airbag; the airbag may be wrapped into the form of the package wrapper to provide variable trajectories of deployment of the airbag. The strip may comprise a polypropylene strip; the strip may comprise a polypropylene material; the strip may comprise a die cut strip; the strip may comprise a sheet-formed strip configured to provide a plurality of mounting configurations in the vehicle interior. The package wrapper may comprise a base provided by the strip wrapped around the airbag to be mounted to a vehicle frame by fasteners. The fold and/or a fixing stitch for the strip can be provided at a first location and/or a second location and/or a third location; a fixing stitch for the strip can be provided at a first location and/or a second location and/or a third location; a fixing stitch for the strip can be attached at a fixed point on the strip defined by the fold. The airbag may be enclosed within the strip of the package wrapper. The stitch for the strip may establish the position of the airbag. The flap of the strip may provide a mounting area for the package wrapper. An airbag assembly may be configured to be contained by the strip wrapped around the airbag. The package wrapper may be formed by the strip wrapped around the airbag. The tab of the package wrapper may be retained to the vehicle frame by a fastener. The strip may comprise a plastic strip and/or an extruded strip and/or a flat-formed sheet and/or a molded sheet and or a sheet-formed cut strip; the strip may comprise a sheet-formed die-cut strip; the strip may comprise an aperture; the strip may be formed in a rotary tool; the strip may comprise an internal weakened area configured to form a tear seam for an opening for deployment of the airbag; the strip may comprise a hole for attachment. The airbag may comprise a rolled cushion pack. The package wrapper may be wrapped around the rolled cushion pack of the airbag. The component may comprise a plurality of package wrappers. The tab may comprise a fabric tab; the tab may comprise a mounting tab. The package wrapper may be stitched to the cushion of the airbag and then stitched to enclose the cushion of the airbag within the strip of the package wrapper; the location of the stitch may determine the position of the airbag; the package wrapper may be formed by stitching the tab at the flap and the fold to close the strip into a form having a shape around the airbag. Slits may be provided on the strip to provide a seam providing a breakout location and direction of deployment for the airbag. Stitches for the package wrapper may be applied by needling through the strip. The strip may comprise a polypropylene material configured so that during deployment of the airbag the strip will break open to facilitate deployment of the airbag and the tab is retained intact.

The present invention relates to a component for a vehicle interior configured to facilitate deployment of an airbag from an airbag module; the vehicle interior component may comprise a set of package assemblies configured to contain the airbag; each assembly may comprise a wrapper configured to contain the airbag; each wrapper may comprise a strip and a tab; each strip may be configured to be wrapped around the airbag; each strip may be configured to provide a fold and a tab; each strip may comprise a seam configured to form an opening for deployment of the airbag; each strip may be closed to retain the airbag; each strip may be configured to provide the fold at a location on the strip to provide a position for retaining the airbag; the location for providing the fold may comprise a plurality of selectable locations; the position for retaining the airbag may comprise a plurality of selectable positions. Each assembly may be configured to retain the airbag in the position to be opened at the seam in the strip and to be retained to the vehicle frame by the tab to direct a trajectory of deployment of the airbag to form a door providing an opening in a trim panel during deployment of the airbag; the position for retaining the airbag may comprise the plurality of selectable positions within a range; each strip may be configured to provide the fold at a first location on the strip to provide a first position for retaining the airbag; each strip may be configured to provide the fold at a second location on the strip to provide a second position for retaining the airbag; the strip may be configured to provide the fold at the first location on the strip to provide a first form comprising the first position for retaining the airbag; the strip may be configured to provide the fold at the second location on the strip to provide a second form comprising the second position for retaining the airbag; the position may comprise a plurality of positions configured to be selected by location of the fold. The wrapper may be configured to retain the airbag in the first position to be opened at a seam in the strip and to be retained to the vehicle frame by the tab to direct a first trajectory of deployment of the airbag; the wrapper may be configured to retain the airbag in the second position to be opened at a seam in the strip and to be retained to the vehicle frame by the tab to direct a second trajectory of deployment of the airbag. The strip may be fixed to retain the airbag; the strip may be sealed to retain the airbag; the strip may be closed by stitching to retain the airbag.

The present invention relates to a component for a vehicle interior configured for deployment of an airbag into the vehicle interior comprising an airbag cushion assembly comprising a cushion and a tab; and a package wrapper for the cushion. The package wrapper may comprise a wrap configured to enclose the airbag cushion. The package wrapper may comprise an extension extending from the wrap. The tab may be sewn to the cushion. The tab may be sewn to the package wrapper. The tab may be sewn to the cushion and the package wrapper. The tab may comprise a mounting tab. The tab may be configured to couple the cushion to a frame of the vehicle. The package wrapper may comprise a unitary construction. The wrap of the package wrapper may extend around the cushion. The package wrapper may be coupled with the cushion. The wrap and the extension may be sewn to the cushion. The package wrapper may be folded to provide the wrap and the extension. The package wrapper may comprise a fold; the package wrapper may be sewn to the cushion at the fold. The package wrapper may comprise a fold; the package wrapper may be sewn to the tab at the fold. The component may comprise a rivet comprising a through hole configured to facilitate coupling of the cushion to a frame of the vehicle. The component may comprise a trim panel. The component may comprise a headliner.

The present invention relates to a method of manufacturing a component for a vehicle interior configured for deployment of an airbag into the vehicle interior comprising providing a package wrapper; providing a cushion for the airbag; folding the package wrapper; coupling the package wrapper with the cushion; rolling the cushion; and closing the package wrapper around the cushion. The step of folding the package wrapper may comprise providing a wrap and an extension. The step of coupling the package wrapper with the cushion may comprise sewing the package wrapper to the cushion at the fold.

### FIGURES

FIGS. 1A and 1B are schematic perspective views of a vehicle according to an exemplary embodiment.

FIGS. 2A and 2B are schematic side elevation views of a vehicle interior according to an exemplary embodiment.

FIGS. 3A and 3B are schematic side elevation views of a vehicle interior component according to an exemplary embodiment.

FIG. 3C is a schematic side elevation view of a wrap/strip for a package for an airbag according to an exemplary embodiment.

FIG. 3D is a schematic top plan view of a wrap/strip for a package for an airbag according to an exemplary embodiment.

FIGS. 3E through 3G are schematic top plan views of a wrap/strip for a package for an airbag according to an exemplary embodiment.

FIG. 3H is a schematic perspective view of a holder/wrapper package for an airbag according to an exemplary embodiment.

FIG. 4 is a schematic perspective view of a holder/wrapper package for an airbag according to an exemplary embodiment.

FIGS. 4A through 4D are schematic perspective detail views of a holder/wrapper package for an airbag according to an exemplary embodiment.

FIGS. 5A through 5C are schematic perspective views of a holder/wrapper package for an airbag according to an exemplary embodiment.

FIGS. 6 through 6C are schematic perspective views of a holder/wrapper package for an airbag according to an exemplary embodiment.

FIGS. 7 through 7C are schematic perspective views of a holder/wrapper package for an airbag according to an exemplary embodiment.

FIGS. 8 through 8C are schematic side elevation views of a holder/wrapper package for an airbag according to an exemplary embodiment.

FIGS. 9A through 10 are schematic perspective detail views of a wrap/strip for a package for an airbag according to an exemplary embodiment.

FIGS. 11 through 11C are schematic side elevation views of a holder/wrapper package for an airbag according to an exemplary embodiment.

FIGS. 12 through 12C are schematic side elevation views of a holder/wrapper package for an airbag according to an exemplary embodiment.

FIGS. 13A through 13C are schematic side elevation views of a vehicle interior component according to an exemplary embodiment.

FIGS. 14A through 14C are schematic side elevation views of a vehicle interior component according to an exemplary embodiment.

FIGS. 15A and 15B are schematic side elevation views of a vehicle interior component according to an exemplary embodiment.

FIGS. 16A and 16B are schematic perspective partial view of a vehicle interior component according to an exemplary embodiment.

FIGS. 17A through 17C are schematic perspective views of a vehicle interior component according to an exemplary embodiment.

FIG. 17D is a schematic perspective exploded view of a vehicle interior component according to an exemplary embodiment.

FIGS. 18A through 18C are schematic perspective views of a vehicle interior component according to an exemplary embodiment.

FIGS. 19A through 19C are schematic perspective views of a vehicle interior component according to an exemplary embodiment.

FIGS. 20A through 20C are schematic perspective views of a vehicle interior component according to an exemplary embodiment.

FIGS. 21A through 21G are schematic side elevation views of a vehicle interior component according to an exemplary embodiment.

FIGS. 22A through 22L are schematic side elevation views of a vehicle interior component according to an exemplary embodiment.

FIGS. 23A through 23I are schematic side elevation views of a vehicle interior component according to an exemplary embodiment.

FIGS. 24A through 24C are schematic flow diagrams of a method of making a vehicle interior component according to an exemplary embodiment.

### DESCRIPTION

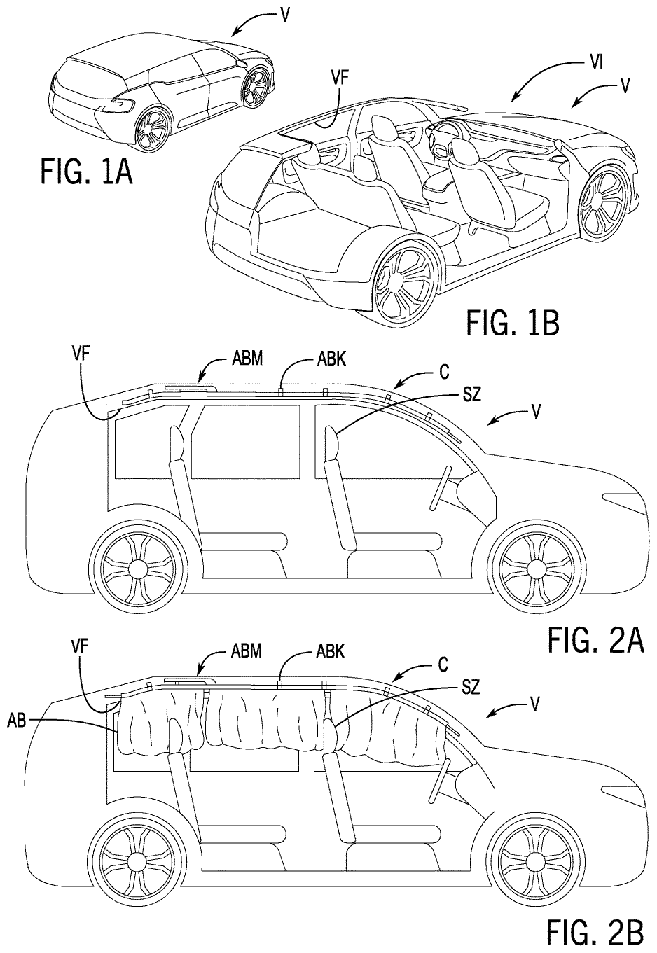

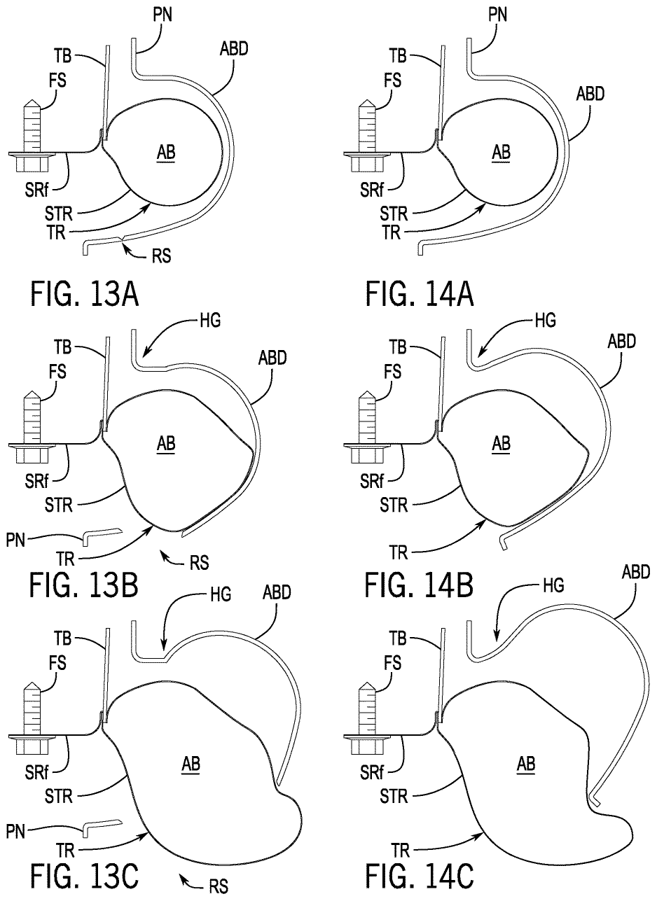

Referring to FIGS. 1A-1B and 2A-2B, a vehicle V comprising a vehicle interior VI is shown according to an exemplary embodiment; the vehicle interior VI may comprise a vehicle/interior frame VF and seats SZ and components C such as trim panels, instrument panels, a door panels, consoles, and other panels/components. As indicated schematically in FIGS. 2A-2B, the component C may comprise an airbag package assembly ABK configured to facilitate deployment of an airbag AB from an airbag module ABM. See also FIGS. 13A-13C and 14A-14C.

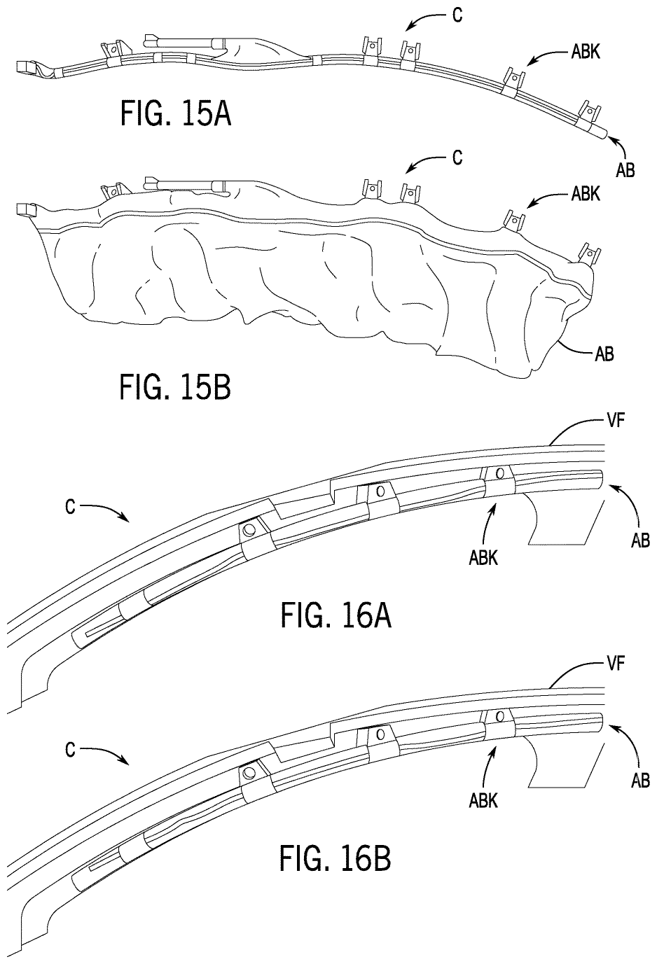

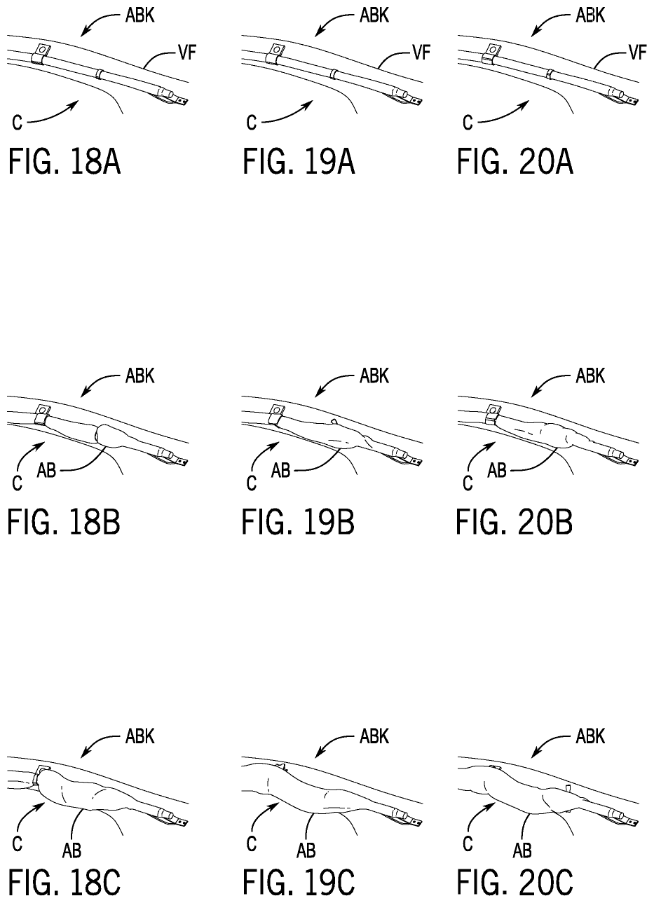

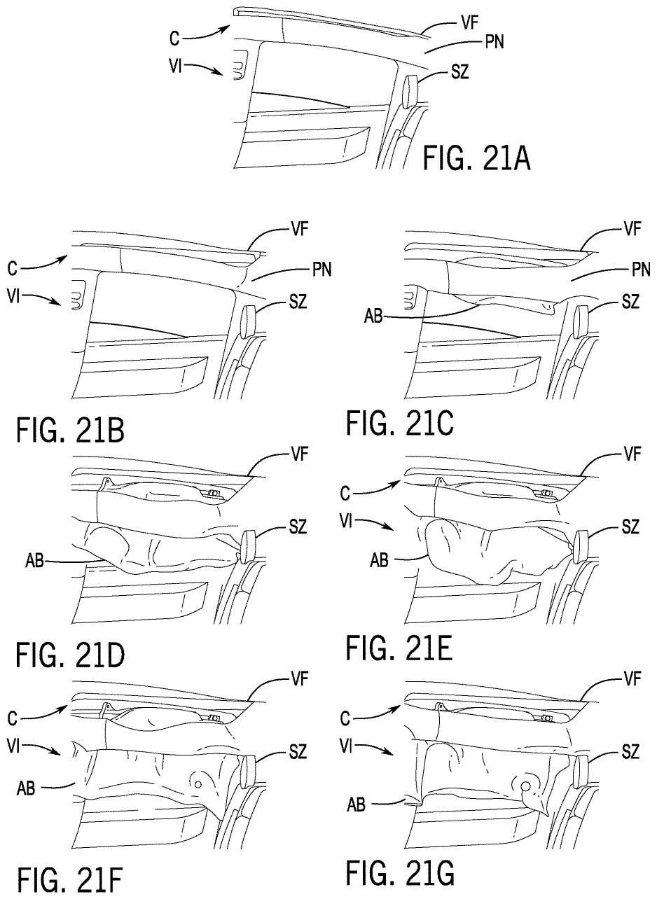

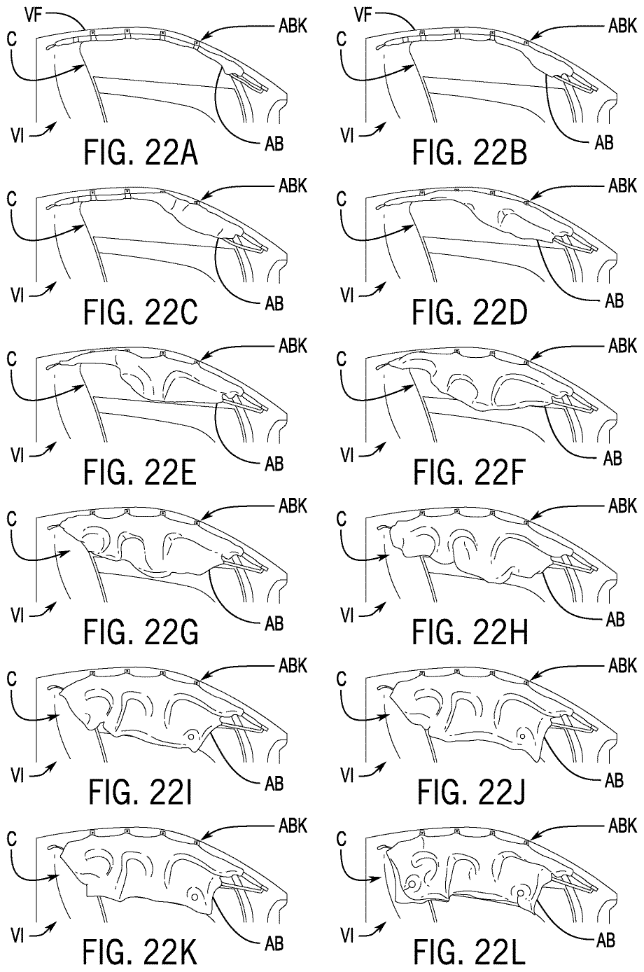

As indicated schematically in FIGS. 2A-2B, 3A-3B, 13A-13C, 14A-14C, 15A-15B, 16A-16B, 18A-18B, 19A-19B and 20A-20C, the component C may comprise an airbag package assembly ABK configured to deploy the airbag AB through a trim panel PN configured to provide an opening at an airbag door ABD; as indicated schematically, the trim panel PN may comprise a side panel and/or overhead panel/headliner; the airbag assembly with airbag AB may comprise a side/curtain airbag assembly. See also FIGS. 21A-21G, 22A-22L and 23A-23I.

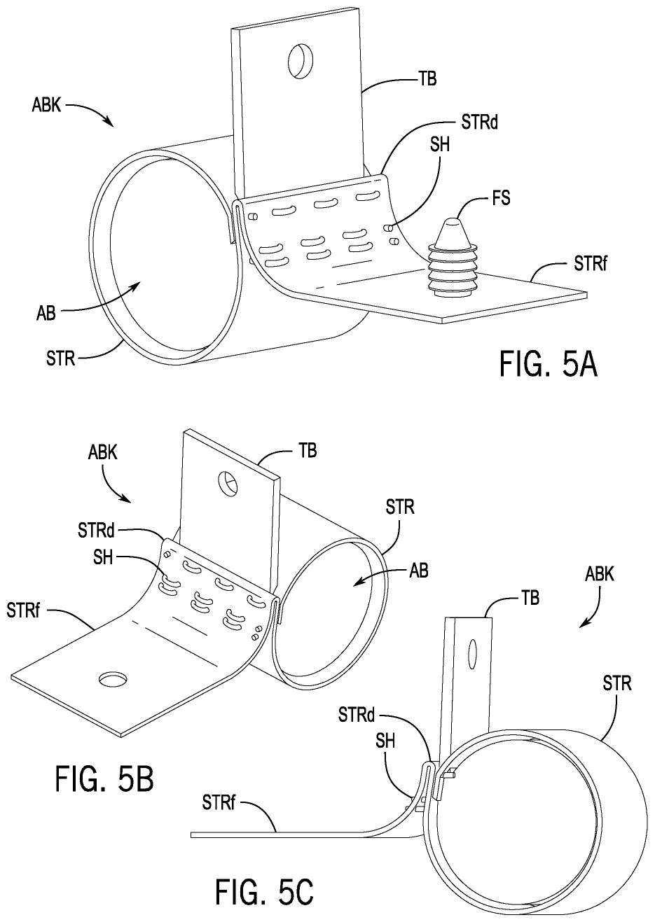

According to an exemplary embodiment as shown schematically in FIGS. 2A-2B, 3A-3B, 5A-5B, 13A-13C, 14A-14C, 15A-15B, 18A-18B, 19A-19B and 20A-20B, the component C may comprise a package wrapper/wrap assembly ABK configured to contain the airbag/assembly AB (e.g. with cushion, etc.); the package/wrapper ABK may be configured to be mounted to the vehicle frame VF to retain the airbag/assembly AB; the airbag AB may be configured to be deployed by inflation from an airbag module ABM through an airbag door ABD formed in the panel/trim during deployment; the airbag door ABD may formed with a hinge/hinge area HG by separation of the panel/trim or at a recess or seam (e.g. tear line) during deployment of the airbag AB; the package/wrapper ABK may comprise a wrap/strip STR to contain the airbag AB; the wrap/strip STR of the package/wrapper ABK may comprise a seam TR configured to provide a tear line to facilitate deployment of the airbag AB. See FIGS. 21A-21G, 22A-22L and 23A-23I.

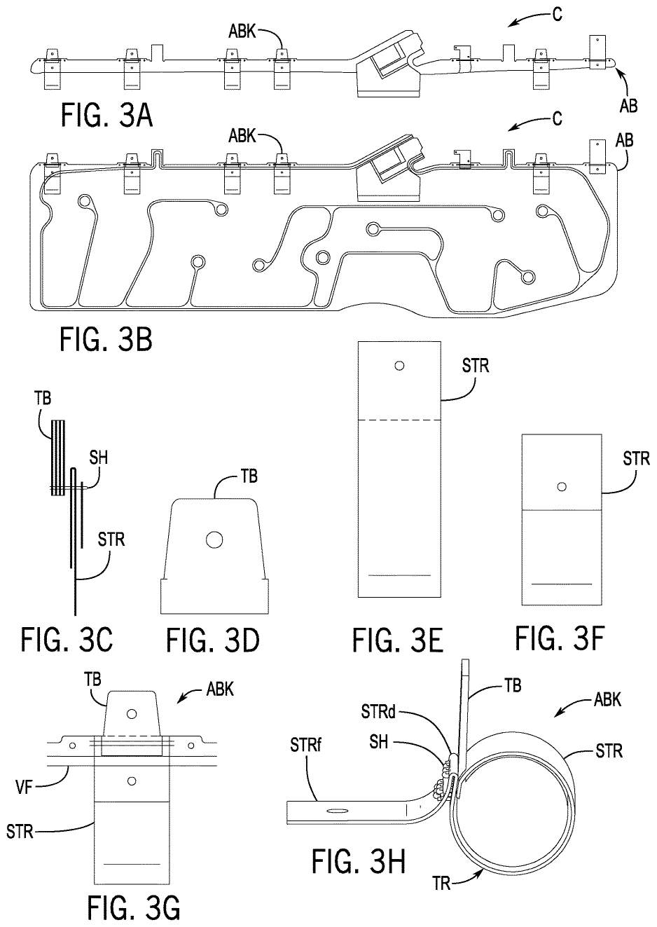

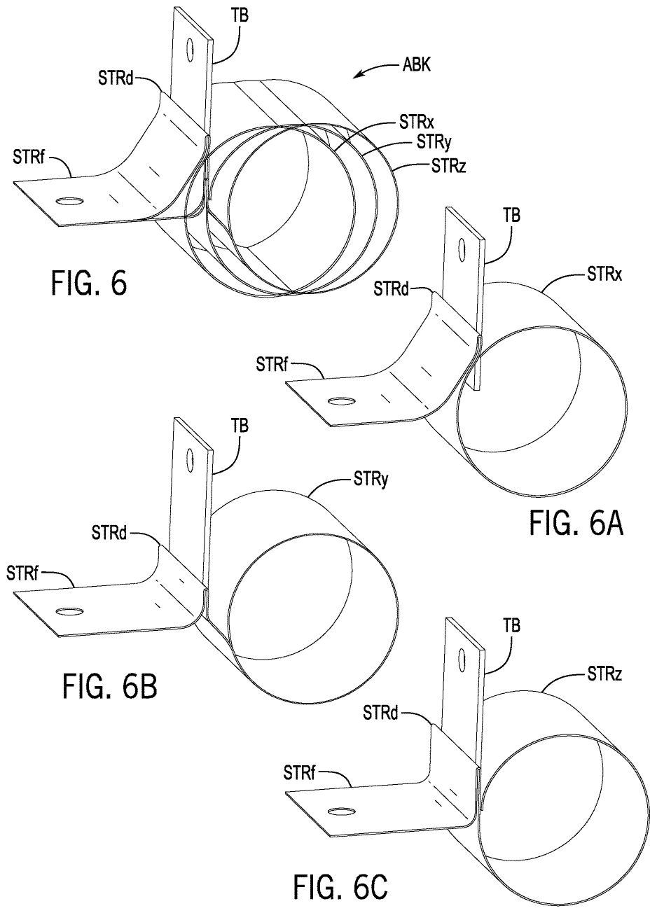

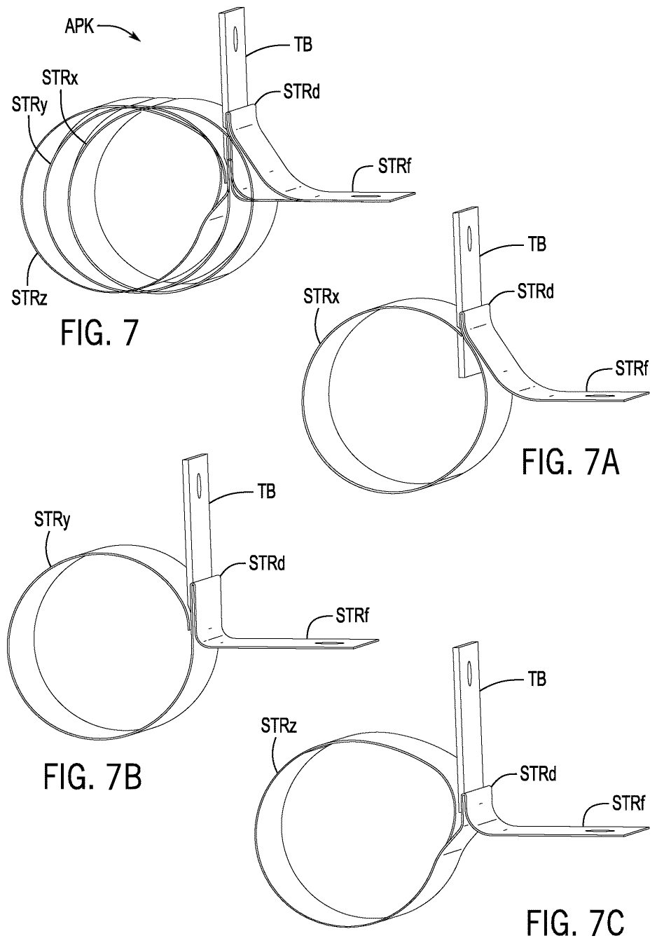

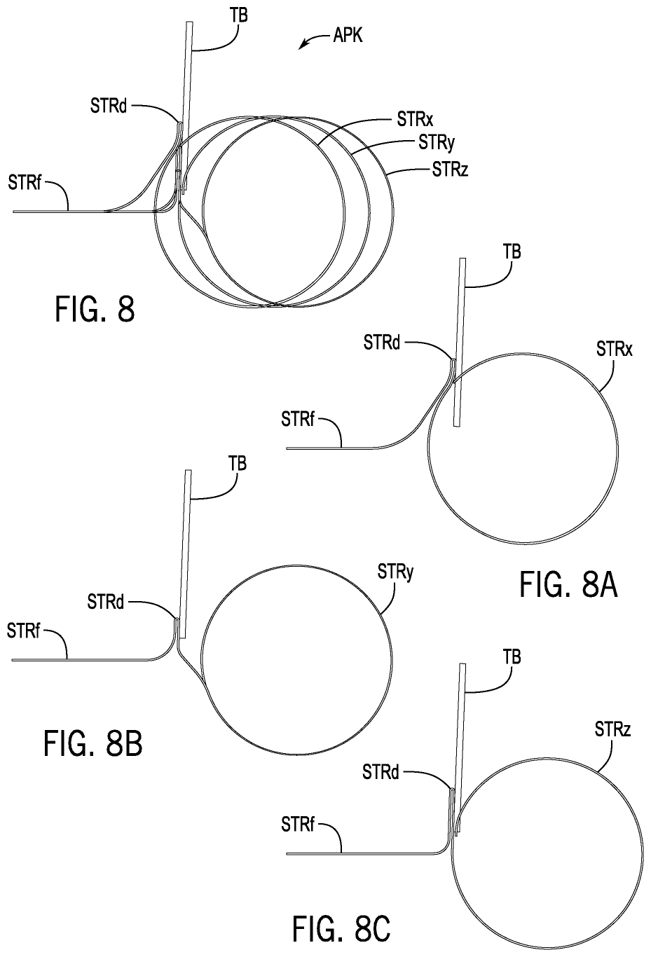

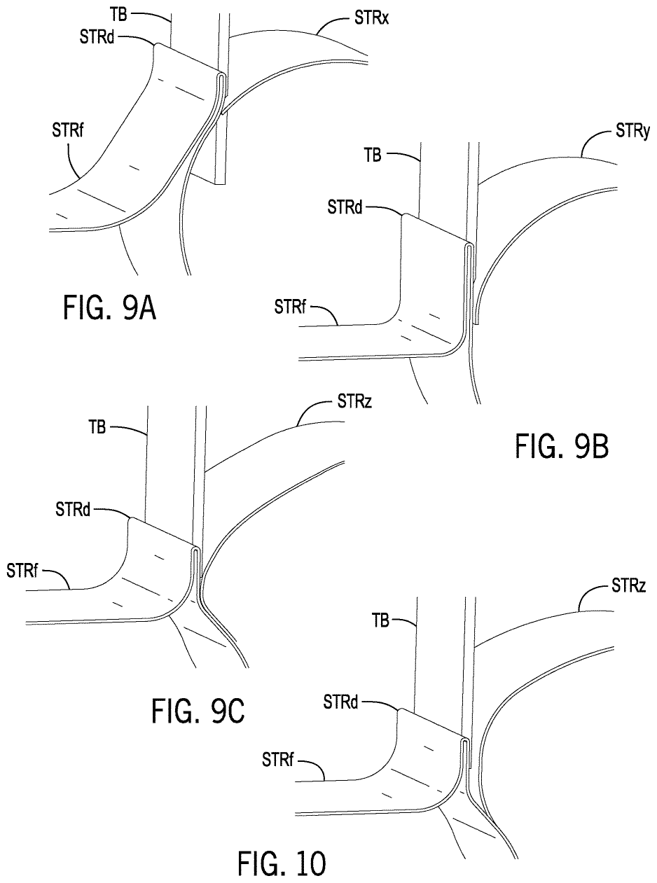

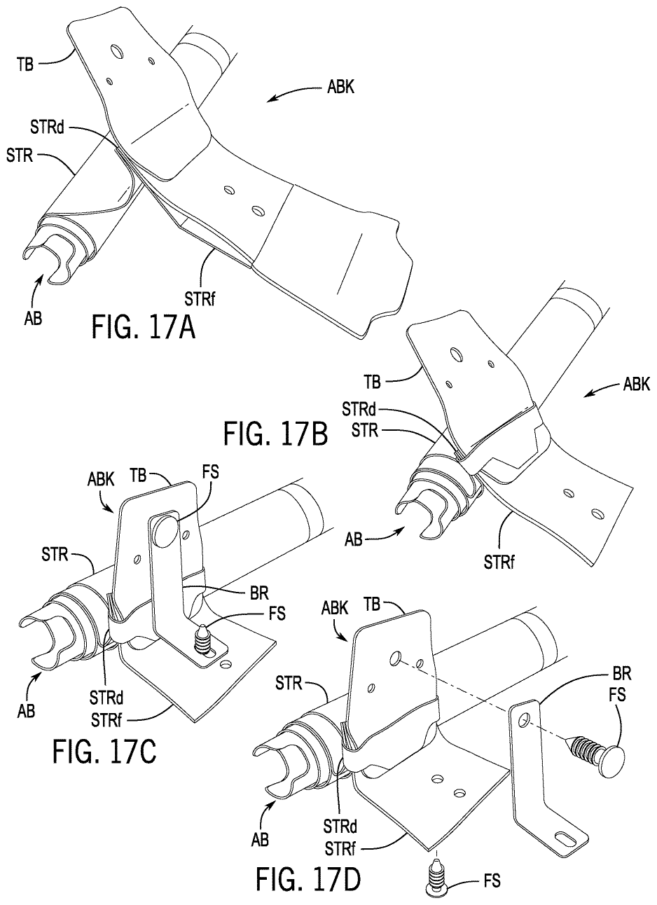

As indicated schematically in FIGS. 2A-2B, 3A-3B and 5A-5B, the component C may comprise a set of airbag package/wrapper/assemblies ABK configured to be attached to the vehicle frame; each package/wrapper ABK may be configured to contain the airbag; the wrapper may comprise a strip STR and a tab TB; the strip STR may be configured to be wrapped around the airbag AB; the strip STR may be configured to provide a fold STRd and a flap/extension STRf. As indicated schematically in FIGS. 3C-3H, 4, 4A-4D, 5A-5C, 9A-9C and 10, the strip STR may be configured to provide the fold STRd at a first location on the strip to provide a first form comprising a first position for retaining the airbag; the strip STR may be configured to provide the fold STRd at a second location on the strip to provide a second form comprising a second position for retaining the airbag; the strip may be closed to retain the airbag; the strip may comprise a seam TR configured to form a tear line for deployment of the airbag. See also FIGS. 17A-17D. As indicated schematically in FIGS. 6, 6A-6C, 7, 7A-7C, 8, 8A-8C, 11, 11A-11C, 12 and 12A-12C, the wrapper/holder ABK may be configured to retain the airbag AB in a first position (indicated as position X) to be opened at the seam TR in the form/strip STRx and to be retained to the vehicle frame by the tab TB to direct a first trajectory of deployment of the airbag AB; the wrapper/holder ABK may be configured to retain the airbag AB in a second position (indicated as position Y) to be opened at the seam TR in the strip STRy and to be retained to the vehicle frame by the tab TB to direct a second trajectory of deployment of the airbag AB; the wrapper/holder ABK may be configured to retain the airbag AB in a third position (indicated as position Z) to be opened at the seam TR in the strip STRz and to be retained to the vehicle frame by the tab TB to direct a third trajectory of deployment of the airbag AB. See also FIGS. 9A-9C, 10, 18A-18C, 19A-19C, 20A-20C and 23A-23I. As indicated schematically in FIGS. 3A-3B, 5A-5C, 15A-15B, 16A-16B, 18A-18C, 19A-19C and 20A-20C, the wrapper/package ABK is configured to contain the airbag AB; the airbag AB may be rolled within the strip STR and secured within the strip STR; the strip STR may be fastened and/or stitched adjacent to the fold STRd to retain the airbag AB and to provide a flap/extension STRf; the strip STR may be closed by stitching/thread shown as stich SH to retain the airbag AB; the strip STR may be fastened/fixed to retain the airbag AB; the strip STR may be sealed/closed by stitching to retain the airbag AB.

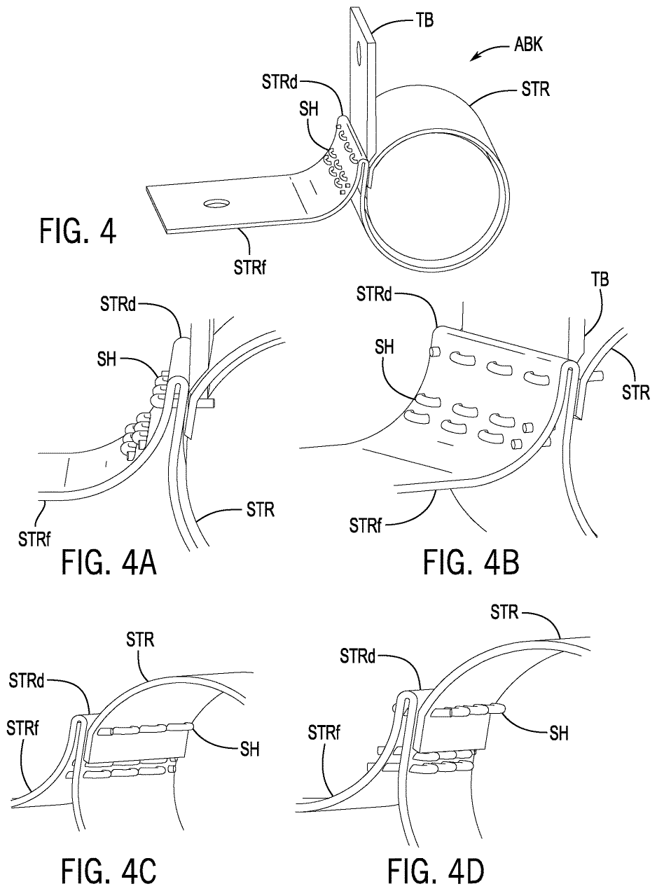

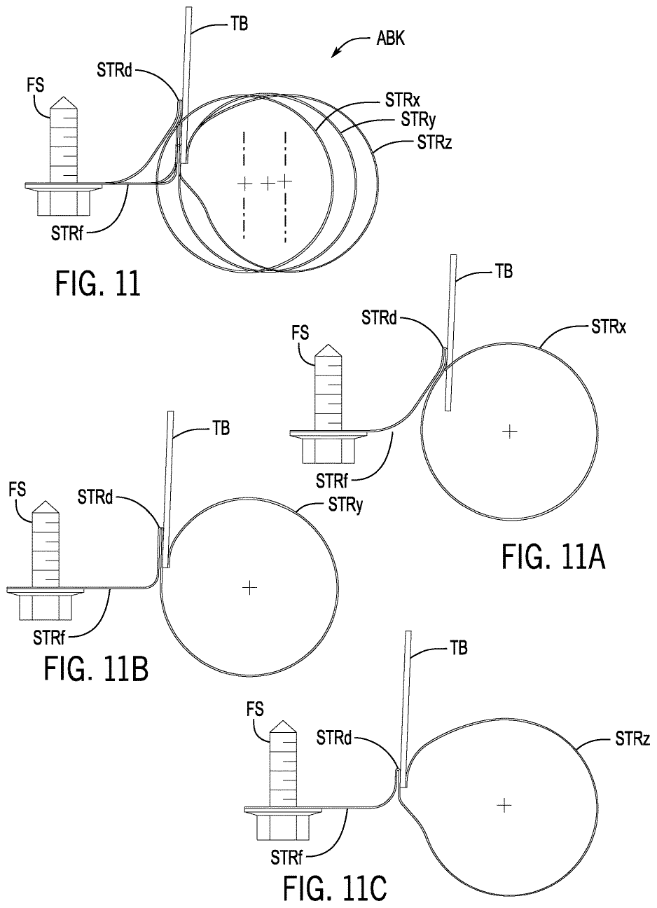

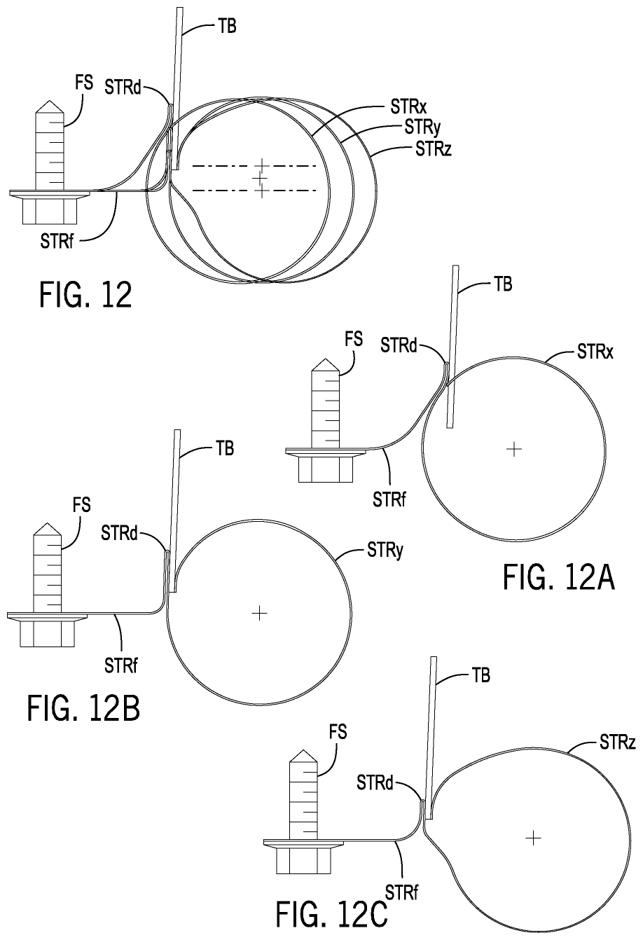

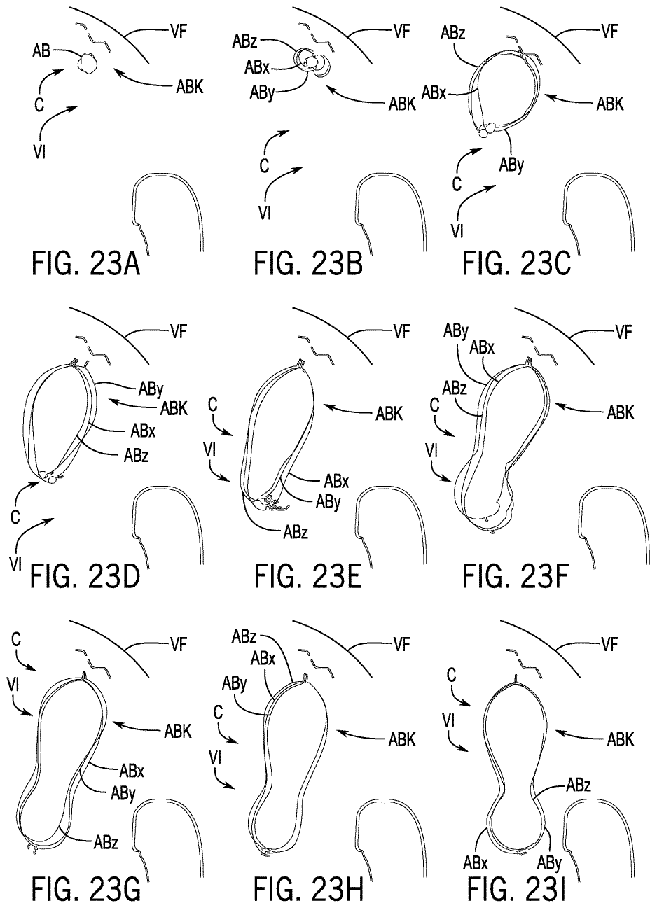

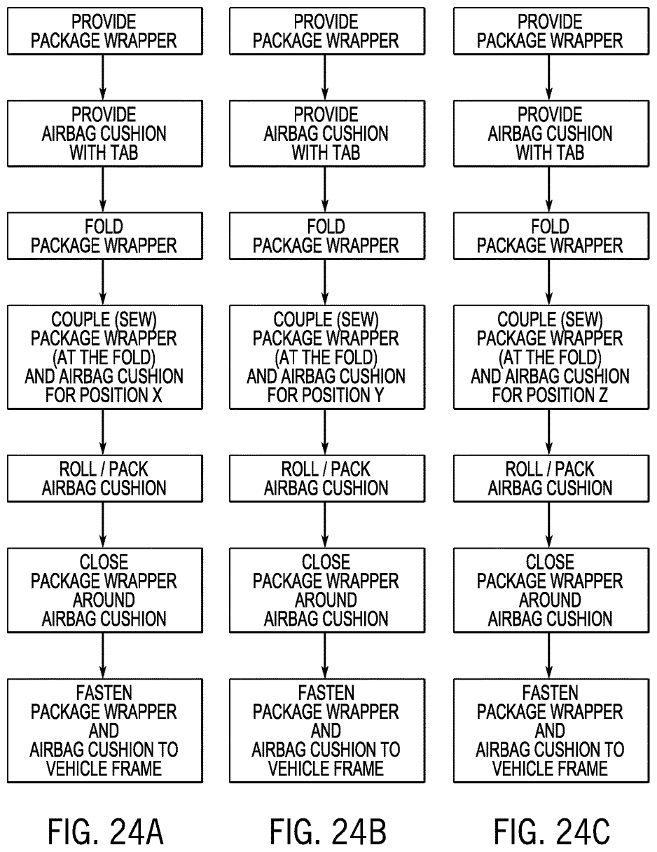

As indicated schematically in FIGS. 6, 6A-6C, 7, 7A-7C, 8, 8A-8C, 11, 11A-11C, 12 and 12A-12C, the component C may be configured to facilitate positioning of the airbag AB within the package assembly ABK at multiple positions in a range of positions by form of the wrap with strip STR shown as near position X with form/strip STRx and intermediate position Y with form/strip STRy and extended position Z with form strip STRz. See also FIGS. 23A-23I and 24A-24C. As indicated schematically in FIGS. 3C-3H, 4, 4A-4D, 5A-5C, 9A-9C and 10, each strip STR may be configured to provide the fold STRd at a location on the strip to provide a position (e.g. in a range of positions) for retaining the airbag AB; the location for providing the fold may comprise a plurality of selectable locations; the position for retaining the airbag may comprise a plurality of selectable positions. See also FIGS. 11, 11A-11C and 12, 12A-12C. As indicated schematically in FIGS. 4, 4A-4D, 5A-5C, 9A-9C, 10, 11, 11A-11C and 12, 12A-12C, the form/strip STR may be provided to retain the airbag in a plurality of selectable positions within a range; each strip may be configured to provide the fold at a first location on the strip to provide a first position for retaining the airbag; each strip may be configured to provide the fold at a second location on the strip to provide a second position for retaining the airbag; the strip may be configured to provide the fold at the first location on the strip to provide a first form comprising the first position for retaining the airbag; the strip may be configured to provide the fold at the second location on the strip to provide a second form comprising the second position for retaining the airbag; the position may comprise a plurality of positions configured to be selected by location of the fold. As indicated schematically in FIGS. 6, 6A-6C, 7, 7A-7C, 8, 8A-8C, 11, 11A-11C, 12, 12A-12C, 18A-18C, 19A-19C and 20A-20C, the wrapper/holder assembly ABK may comprise a wrapper/holder provided by strip STR configured to be adjustable by location of a stitch SH and/or a fold STRd to provide multiple mounting positions within a range; the strip of the wrapper package assembly may be configured to retain and/or contain the airbag and to provide a form for the package wrapper when folded at the fold to provide the flap; the stitch may be provided adjacent to the fold by a stitch at a location. As indicated schematically in FIGS. 4, 4A-4D, 5A-5C, 9A-9C, 10, 11, 11A-11C and 12, 12A-12C, the form/strip STR may comprise a first form STRx when the stitch is at a first location and a second form STRy when the stitch is at a second location; the form may comprise a third form STRz when the stitch is at a third location. As indicated schematically in FIGS. 3C-3H, 4, 4A-4D, 5A-5C, 9A-9C and 10, fastening of/on strip STR may comprise an upper fastening to provide a form for the wrapper and a lower fastening to facilitate routing for trajectory of airbag deployment; a stitch on the strip may comprise an upper stitch to provide a form for the wrapper and a lower stitch to facilitate routing for trajectory of airbag deployment; the package wrapper may be stitched to the cushion of the airbag and stitched to enclose the cushion of the airbag within the strip of the package wrapper; the location of the stitch may determine the position of the airbag; the package wrapper may be formed by stitching the tab at the flap and the fold to close the strip into a form having a shape around the airbag; slits may be provided on the strip to provide a seam providing a breakout location and direction of deployment for the airbag; stitches for the package wrapper may be applied by needling through the strip. As indicated schematically, the strip may comprise a polypropylene material configured so that during deployment of the airbag the strip will break open to facilitate deployment of the airbag and the tab is retained intact.

As indicated schematically in FIGS. 6, 7, 8, 11, 12, 18A-18C, 19A-19C, 20A-20C and 23A-23I, the wrapper/package assembly ABK may be configured with the wrap/strip STR to retain the airbag AB in multiple positions for routing/deployment from a range of positions; the wrapper/package assembly ABK may be configured to be opened at a seam TR in the strip STR and to be retained to the vehicle frame VF by the tab TB to direct a trajectory of deployment of the airbag AB into the vehicle interior VI; the wrapper/package assembly ABK may be configured to retain the airbag AB in a range of positions such as a first/near position X with form/strip STRx and a second/intermediate position Y with form/strip STRy and a third/extended position Z with form/strip STRz. See also FIGS. 6A-6C, 7A-7C, 8A-8C, 11A-11C, and 12A-12C.

According to an exemplary embodiment shown schematically in the FIGS. 2A-2B, 13A-13C and 14A-14C, a component C for a vehicle interior may comprise a trim panel PN; a set of wrapper/holder assemblies ABK may be configured to be installed behind the trim panel PN; the vehicle interior VI may comprise a vehicle frame VF behind the trim panel; a set of wrapper/holder assemblies ABK may be configured to be installed to the vehicle frame VF behind the trim panel PN; each holder assembly of the set of holder assemblies may be configured to be attached to the vehicle frame by a set of fasteners FS and/or with a bracket BR (e.g. through an aperture at the tab, flap, etc.); each fastener may comprise a pin or a bolt or a rivet or a plastic fastener. See also FIGS. 17A-17D. As indicated schematically in FIGS. 13A-13C, each wrapper/holder ABK may be configured to direct formation of an opening for deployment of the airbag AB through an opening forming a door ABD with a hinge/hinge area HG at a recess RS to provide a tear line in the panel PN. As indicated schematically in FIGS. 14A-14C, each wrapper/holder ABK may be configured to direct formation of an opening for deployment of the airbag AB through an opening forming a door ABD with a hinge/hinge area HG by separation of the panel PN. As indicated schematically, each wrapper/holder may be configured to direct formation of an opening in the trim panel for deployment of the airbag and to direct trajectory of deployment of the airbag; each holder may be configured to retain the airbag in a position to direct formation of an opening in the trim panel for deployment of the airbag. According to an exemplary embodiment as shown schematically in FIGS. 3C-3H, 4, 4A-4D, 5A-5C, 9A-9C and 10, a component C for a vehicle interior VI configured for deployment of an airbag AB into the vehicle interior VI may comprise an airbag cushion assembly comprising an airbag/cushion AB and a package wrapper/holder ABK for the airbag/cushion AB and a wrap/strip STR with a fold STRd and a flap/extension STRf and a tab TB; the wrap/strip STR may be configured to enclose the airbag/cushion AB; the tab TB may be sewn to the airbag/cushion AB; the tab TB may be sewn to wrap/strip STR of the package wrapper/holder ABK; the tab may be sewn to the airbag/cushion AB and to the wrap/strip STR of the package wrapper ABK. The component may comprise a trim panel PN configured to provide an airbag door ABD for deployment of an airbag AB; the trim panel PN may comprise an overhead panel/headliner; the airbag assembly with airbag AB may comprise a side/curtain airbag assembly. See FIGS. 2A-2B, 13A-13C and 14A-14B, 21A-21G, 22A-22L and 23A-23I.

According to an exemplary embodiment as shown schematically in the FIGS. 24A-24C, a method of manufacturing a component for a vehicle interior configured for deployment of an airbag into the vehicle interior may comprise providing a package wrapper; providing a cushion for the airbag; folding the package wrapper; coupling the package wrapper with the cushion; rolling the cushion; and closing the package wrapper around the cushion. The step of folding the package wrapper may comprise providing a wrap and an extension. The step of coupling the package wrapper with the cushion may comprise sewing the package wrapper to the cushion at the fold. A method of manufacturing a component for a vehicle interior configured for deployment of an airbag into the vehicle interior may comprise providing a package wrapper; providing an airbag cushion with a tab; folding the package wrapper; coupling (e.g. sewing) the package wrapper (e.g. at the fold) and the airbag cushion; rolling the airbag cushion; closing the package wrapper around the airbag cushion; and fastening the package wrapper and the airbag cushion to a frame of the vehicle. As indicated schematically in FIGS. 6, 6A-6C, 7, 7A-7C, 8, 8A-8C, 11, 11A-11C, 12 and 12A-12C, the method may facilitate positioning of the airbag AB within the package assembly ABK at multiple positions in a range of positions by form of the wrap with strip STR shown as near position X with form/strip STRx and intermediate position Y with form/strip STRy and extended position Z with form strip STRz. See also FIGS. 23A-23I and 24A-24C.

According to an exemplary embodiment as shown schematically in FIGS. 3A-3B, 5A-5C, 15A-15B, 16A-16B,18A-18C, 19A-19C and 20A-20C, a component C configured to facilitate deployment of an airbag AB from an airbag assembly into the vehicle interior VI may comprise a package assembly ABK configured to mount/retain the airbag assembly/airbag AB; a component C configured to facilitate deployment of an airbag AB from an airbag assembly into the vehicle interior VI may comprise a wrapper/package assembly ABK configured to mount/retain the airbag assembly/airbag AB in multiple positions. According to an exemplary embodiment as shown schematically in, a component C configured to facilitate deployment of an airbag from an airbag assembly into the vehicle interior VI may comprise a wrapper/package assembly ABK configured to mount/retain the airbag assembly/airbag AB in multiple positions to facilitate installation of the airbag assembly in the vehicle interior VI; a component C configured to facilitate deployment of an airbag AB from an airbag assembly into the vehicle interior VI may comprise a wrapper/package assembly ABK configured to mount/retain the airbag assembly/airbag AB in multiple positions to facilitate direction of routing of deployment of the airbag AB into the vehicle interior VI. See also FIGS. 6, 6A-6C, 7, 7A-7C, 8, 8A-8C, 11, 11A-11C, 12, 12A-12C, 21A-21G, 22A-22L and 23A-23I.

### Exemplary Embodiments—A

According to an exemplary embodiment shown schematically in the FIGURES, a component for a vehicle interior configured to facilitate deployment of an airbag from an airbag module; the component may comprise a set of airbag package wrappers configured to be attached to the vehicle frame; each wrapper may be configured to contain the airbag; the wrapper may comprise a strip and a tab; the strip may be configured to be wrapped around the airbag; the strip may be configured to provide a fold and a tab secured to the strip; the strip may be configured to provide the fold at a first location on the strip to provide a first form comprising a first position for retaining the airbag; the strip may be configured to provide the fold at a second location on the strip to provide a second form comprising a second position for retaining the airbag; the strip may be closed to retain the airbag; the strip may comprise a seam configured to form a tear line for deployment of the airbag; the wrapper may be configured to retain the airbag in the first position to be opened at the seam in the strip and to be retained to the vehicle frame by the tab to direct a first trajectory of deployment of the airbag; the wrapper may be configured to retain the airbag in the second position to be opened at the seam in the strip and to be retained to the vehicle frame by the tab to direct a second trajectory of deployment of the airbag; the airbag may be rolled within the strip and secured within the strip; the strip may be closed adjacent to the fold to retain the airbag; the strip may be fixed adjacent to the fold to retain the airbag; the strip may be fixed by stitching to retain the airbag.

According to an exemplary embodiment shown schematically in the FIGURES, a component for a vehicle interior configured to facilitate deployment of an airbag from an airbag module into a vehicle interior may comprise a set of holder assemblies configured to contain the airbag; each holder assembly may comprise a wrapper configured to contain the airbag; the wrapper may comprise a strip and a tab; the strip may be configured to be wrapped around the airbag; the strip may be configured to provide a fold and a tab; the strip may be configured to provide the fold at a first location on the strip to provide a first position for retaining the airbag; the strip may be configured to provide the fold at a second location on the strip to provide a second position for retaining the airbag; the strip may be closed to retain the airbag; the strip may be configured to provide the fold at the first location on the strip to provide a first form comprising the first position for retaining the airbag; the strip may be configured to provide the fold at the second location on the strip to provide a second form comprising the second position for retaining the airbag. The wrapper may be configured to retain the airbag in the first position to be opened at a seam in the strip and to be retained to the vehicle frame by the tab to direct a first trajectory of deployment of the airbag; the wrapper may be configured to retain the airbag in the second position to be opened at a seam in the strip and to be retained to the vehicle frame by the tab to direct a second trajectory of deployment of the airbag. The strip may be fixed to retain the airbag; the strip may be sealed to retain the airbag; the strip may be closed by stitching to retain the airbag; the strip may be fixed by stitching to retain the airbag; the strip may be closed adjacent to the fold to retain the airbag; the strip may be fixed adjacent to the fold to retain the airbag; the strip may be secured by thread to retain the airbag; the strip may be sewn to retain the airbag; the strip may be stitched to retain the airbag; the strip may comprise a weakening line to facilitate tearing of the strip to facilitate deployment of the airbag. The tab may be secured to the strip; the tab may be secured on the strip; the tab may be secured within the strip; the tab may be fastened to the strip; the tab may be stitched on the strip; the tab may be adhered to the strip; the tab may be secured to the strip adjacent to the fold of the strip; the fold of the strip may be made adjacent to where the tab may be secured to the strip; the tab may be secured on the strip and the airbag may be wrapped within the strip and secured within the strip. The airbag may be secured to the strip; the airbag may be secured within the strip; the airbag may be rolled within the strip and secured within the strip; the airbag may be wrapped within the strip and secured within the strip; the airbag may comprise a generally cylindrical shape; the airbag may comprise a generally tubular shape; the airbag may be rolled into a generally tubular shape; the airbag may be rolled into a generally cylindrical shape. The strip may be configured to provide the fold at a third location on the strip to provide a third position for retaining the airbag. The holder assembly may be configured to be mounted to a vehicle frame; the holder assembly may be configured to be mounted to a vehicle frame in the vehicle interior; the holder assembly may be configured to form a tube-shaped holder; the holder assembly may be configured to form a tube-shaped holder when the strip is folded to provide the fold and fixed to provide the flap.

According to an exemplary embodiment shown schematically in the FIGURES, a component for a vehicle interior may comprise a trim panel; a set of holder assemblies may be configured to be installed behind the trim panel; the vehicle interior may comprise a vehicle frame behind the trim panel; a set of holder assemblies may be configured to be installed to the vehicle frame; the set of holder assemblies may be configured to be installed to the vehicle frame behind the trim panel; the set of holder assemblies may be configured to be attached to the vehicle frame behind the trim panel; each holder assembly of the set of holder assemblies may be configured to be attached to the vehicle frame behind the trim panel; each holder assembly of the set of holder assemblies may be configured to be attached to the vehicle frame by a set of fasteners; each holder assembly of the set of holder assemblies may be configured to be attached to the vehicle frame by a pair of fasteners; each holder assembly of the set of holder assemblies may be configured to be attached to the vehicle frame by a fastener at the tab; each holder assembly of the set of holder assemblies may be configured to be attached to the vehicle frame by a fastener through an aperture at the tab; each holder assembly of the set of holder assemblies may be configured to be attached to the vehicle frame by a rivet at the tab; each holder assembly of the set of holder assemblies may be configured to be attached to the vehicle frame by a fastener at the flap of the strip; each holder assembly of the set of holder assemblies may be configured to be attached to the vehicle frame by a fastener through an aperture at the flap of the strip; each holder assembly of the set of holder assemblies may be configured to be attached to the vehicle frame by a bolt at the flap of the strip; each holder assembly of the set of holder assemblies may be configured to be attached to the vehicle frame by an expansion bolt at the flap of the strip; each holder assembly of the set of holder assemblies may be configured to be attached to the vehicle frame by a fastener at the tab and a fastener at the flap of the strip; each fastener may comprise a pin or a bolt or a rivet or a plastic fastener; each holder may be configured to direct formation of an opening for deployment of the airbag; each holder may be configured to direct formation of an opening in the trim panel for deployment of the airbag; each holder may be configured to retain the airbag in a position to direct deployment of the airbag; each holder may be configured to retain the airbag in a position to direct trajectory of deployment of the airbag; each holder may be configured to retain the airbag in a position to direct formation of an opening in the trim panel for deployment of the airbag. The trim panel may be configured to form an opening for deployment of the airbag; the trim panel may be configured to form a door for deployment of the airbag; the trim panel may comprise a seam configured to form a door for deployment of the airbag; the trim panel may be configured to provide a hinge for the door for deployment of the airbag; the trim panel may be configured to provide a tear line for the door for deployment of the airbag; the trim panel may be configured to provide a separation for the door for deployment of the airbag; the trim panel may be configured to provide an opening at the door for deployment of the airbag.

According to an exemplary embodiment shown schematically in the FIGURES, each holder assembly may be configured to provide a seam for deployment of the airbag; each holder assembly may be configured to provide a tear line for deployment of the airbag; each holder assembly may be configured to provide a tear line at a seam in the strip for deployment of the airbag; the seam may comprise a perforation; the seam may comprise a perforation line; the seam may comprise a perforation in the strip; the seam may comprise a line of perforations in the strip; the seam may comprise a perforation line in the strip wrapped around the airbag; each holder assembly may comprise a seam for the tear line in the strip for deployment of the airbag; each holder may be separated at the seam in the strip during deployment of the airbag; each holder may be opened at the seam in the strip during deployment of the airbag; each holder may be retained by the tab during deployment of the airbag; each holder may be retained to the vehicle frame by the tab during deployment of the airbag; each holder may be retained to the vehicle frame by the tab after deployment of the airbag; each holder may be opened at the seam in the strip and retained to the vehicle frame by the tab during deployment of the airbag; each holder may be configured to retain the airbag in a position to be opened at the seam in the strip and to be retained to the vehicle frame by the tab during deployment of the airbag; each holder may be configured to retain the airbag in a position to be opened at the seam in the strip and to be retained to the vehicle frame by the tab to direct trajectory of deployment of the airbag.

According to an exemplary embodiment shown schematically in the FIGURES, each holder may be configured to retain the airbag in a first position to be opened at the seam in the strip and to be retained to the vehicle frame by the tab to direct a first trajectory of deployment of the airbag; each holder may be configured to retain the airbag in a second position to be opened at the seam in the strip and to be retained to the vehicle frame by the tab to direct a second trajectory of deployment of the airbag; each holder may be configured to retain the airbag in a third position to be opened at the seam in the strip and to be retained to the vehicle frame by the tab to direct a third trajectory of deployment of the airbag; each holder may be configured to retain the airbag in a position to be opened at the seam in the strip and to be retained to the vehicle frame by the tab to direct a trajectory of deployment of the airbag to form a door providing an opening in a trim panel during deployment of the airbag; the position may comprise a plurality of selectable positions; the holder assembly may comprise a package assembly; the holder assembly may comprise a wrapper package assembly; the holder assembly may comprise a wrapper package assembly configured to retain an airbag in multiple positions; the holder assembly may comprise a wrapper package assembly configured to be adjustable by location of a stitch and/or a fold to provide multiple mounting positions within a range; the wrapper package assembly may be configured to retain and/or contain the airbag; the holder assembly may comprise a package wrapper configured to contain the airbag and to be mounted to a vehicle frame; the holder assembly may comprise a package wrapper. The strip may be configured to provide a form when folded at the fold to provide the flap to be retained at the fold by a stitch; the strip may be configured to be fixed to provide a form for the package wrapper when folded at the fold to provide the flap to be retained at the fold by a stitch at a location; the form may comprise a first form when the stitch is at a first location and a second form when the stitch is at a second location; the form may comprise a third form when the stitch is at a third location and a fourth form when the stitch is at a fourth location. The airbag may be wrapped into the form of the package wrapper; the airbag may be wrapped into the form of the package wrapper to provide variable mounting positions for the airbag; the airbag may be wrapped into the form of the package wrapper to provide variable trajectories of deployment of the airbag.

According to an exemplary embodiment shown schematically in the FIGURES, the strip may comprise a polypropylene strip; the strip may comprise a polypropylene material; the strip may comprise a die cut strip; the strip may comprise a sheet-formed strip configured to provide a plurality of mounting configurations in the vehicle interior. The package wrapper may comprise a base provided by the strip wrapped around the airbag to be mounted to a vehicle frame by fasteners. The fold and/or a fixing stitch for the strip can be provided at a first location and/or a second location and/or a third location; a fixing stitch for the strip can be provided at a first location and/or a second location and/or a third location; a fixing stitch for the strip can be attached at a fixed point on the strip defined by the fold. The airbag may be enclosed within the strip of the package wrapper. The stitch for the strip may establish the position of the airbag. The flap of the strip may provide a mounting area for the package wrapper. An airbag assembly may be configured to be contained by the strip wrapped around the airbag. The package wrapper may be formed by the strip wrapped around the airbag. The tab of the package wrapper may be retained to the vehicle frame by a fastener. The strip may comprise a plastic strip and/or an extruded strip and/or a flat-formed sheet and/or a molded sheet and or a sheet-formed cut strip; the strip may comprise a sheet-formed die-cut strip; the strip may comprise an aperture; the strip may be formed in a rotary tool; the strip may comprise an internal weakened area configured to form a tear seam for an opening for deployment of the airbag; the strip may comprise a hole for attachment.

According to an exemplary embodiment shown schematically in the FIGURES, the airbag may comprise a rolled cushion pack. The package wrapper may be wrapped around the rolled cushion pack of the airbag. The component may comprise a plurality of package wrappers. The tab may comprise a fabric tab; the tab may comprise a mounting tab. The package wrapper may be stitched to the cushion of the airbag and then stitched to enclose the cushion of the airbag within the strip of the package wrapper; the location of the stitch may determine the position of the airbag; the package wrapper may be formed by stitching the tab at the flap and the fold to close the strip into a form having a shape around the airbag. Slits may be provided on the strip to provide a seam providing a breakout location and direction of deployment for the airbag. Stitches for the package wrapper may be applied by needling through the strip. The strip may comprise a polypropylene material configured so that during deployment of the airbag the strip will break open to facilitate deployment of the airbag and the tab is retained intact.

According to an exemplary embodiment shown schematically in the FIGURES, a component for a vehicle interior configured to facilitate deployment of an airbag from an airbag module into a vehicle interior may comprise a set of package assemblies configured to contain the airbag; each assembly may comprise a wrapper configured to contain the airbag; each wrapper may comprise a strip and a tab; each strip may be configured to be wrapped around the airbag; each strip may be configured to provide a fold and a tab; each strip may comprise a seam configured to form an opening for deployment of the airbag; each strip may be closed to retain the airbag; each strip may be configured to provide the fold at a location on the strip to provide a position for retaining the airbag; the location for providing the fold may comprise a plurality of selectable locations; the position for retaining the airbag may comprise a plurality of selectable positions. Each assembly may be configured to retain the airbag in the position to be opened at the seam in the strip and to be retained to the vehicle frame by the tab to direct a trajectory of deployment of the airbag to form a door providing an opening in a trim panel during deployment of the airbag; the position for retaining the airbag may comprise the plurality of selectable positions within a range; each strip may be configured to provide the fold at a first location on the strip to provide a first position for retaining the airbag; each strip may be configured to provide the fold at a second location on the strip to provide a second position for retaining the airbag; the strip may be configured to provide the fold at the first location on the strip to provide a first form comprising the first position for retaining the airbag; the strip may be configured to provide the fold at the second location on the strip to provide a second form comprising the second position for retaining the airbag; the position may comprise a plurality of positions configured to be selected by location of the fold. The wrapper may be configured to retain the airbag in the first position to be opened at a seam in the strip and to be retained to the vehicle frame by the tab to direct a first trajectory of deployment of the airbag; the wrapper may be configured to retain the airbag in the second position to be opened at a seam in the strip and to be retained to the vehicle frame by the tab to direct a second trajectory of deployment of the airbag. The strip may be fixed to retain the airbag; the strip may be sealed to retain the airbag; the strip may be closed by stitching to retain the airbag.

### Exemplary Embodiments—B

According to an exemplary embodiment as shown schematically in the FIGURES, a component for a vehicle interior configured for deployment of an airbag into the vehicle interior may comprise an airbag cushion assembly comprising a cushion and a tab; and a package wrapper for the cushion. The package wrapper may comprise a wrap configured to enclose the airbag cushion. The package wrapper may comprise an extension extending from the wrap. The tab may be sewn to the cushion. The tab may be sewn to the package wrapper. The tab may be sewn to the cushion and the package wrapper. The tab may comprise a mounting tab. The tab may be configured to couple the cushion to a frame of the vehicle. The package wrapper may comprise a unitary construction. The wrap of the package wrapper may extend around the cushion. The package wrapper may be coupled with the cushion. The wrap and the extension may be sewn to the cushion. The package wrapper may be folded to provide the wrap and the extension. The package wrapper may comprise a fold; the package wrapper may be sewn to the cushion at the fold. The package wrapper may comprise a fold; the package wrapper may be sewn to the tab at the fold. The component may comprise a rivet comprising a through hole configured to facilitate coupling of the cushion to a frame of the vehicle. The component may comprise a trim panel. The component may comprise a headliner.

According to an exemplary embodiment as shown schematically in FIGS. 24A-24C, a method of manufacturing a component for a vehicle interior configured for deployment of an airbag into the vehicle interior may comprise providing a package wrapper; providing an airbag cushion with a tab; folding the package wrapper; coupling (e.g. sewing) the package wrapper (e.g. at the fold) and the airbag cushion; rolling the airbag cushion; closing the package wrapper around the airbag cushion; and fastening the package wrapper and the airbag cushion to a frame of the vehicle. As indicated schematically in FIGS. 6, 6A-6C, 7, 7A-7C, 8, 8A-8C, 11, 11A-11C, 12 and 12A-12C, the method facilitates positioning of the airbag AB within the package assembly ABK at multiple positions in a range of positions by form of the wrap with strip STR shown as near position X with form/strip STRx and intermediate position Y with form/strip STRy and extended position Z with form strip STRz. See also FIGS. 23A-23I and 24A-24C. A method of manufacturing a component for a vehicle interior configured for deployment of an airbag into the vehicle interior may comprise providing a package wrapper; providing a cushion for the airbag; folding the package wrapper; coupling the package wrapper with the cushion; rolling the cushion; and closing the package wrapper around the cushion. The step of folding the package wrapper may comprise providing a wrap and an extension. The step of coupling the package wrapper with the cushion may comprise sewing the package wrapper to the cushion at the fold.

### Exemplary Embodiments—X

The present invention relates to a component for a vehicle interior comprising a vehicle frame configured to facilitate deployment of an airbag from an airbag module comprising a set of airbag package wrappers configured to be attached to the vehicle frame; a wrapper of the set of airbag package wrappers may be configured to contain the airbag; the wrapper may comprise a strip and a tab; the strip may be configured to be wrapped around the airbag; the strip may be configured to provide a fold; the strip may be configured to provide the fold at a first location on the strip to provide a first form comprising a first position for retaining the airbag; the strip may be configured to provide the fold at a second location on the strip to provide a second form comprising a second position for retaining the airbag; the strip may be closed to retain the airbag; the strip may comprise a seam configured to form a tear line for deployment of the airbag; the wrapper may be configured to retain the airbag in the first position to be opened at the seam in the strip and to be retained to the vehicle frame by the tab to direct a first trajectory of deployment of the airbag; the wrapper may be configured to retain the airbag in the second position to be opened at the seam in the strip and to be retained to the vehicle frame by the tab to direct a second trajectory of deployment of the airbag. A wrapper of the set of airbag package wrappers may be configured to contain the airbag; the airbag may be rolled within the strip and secured within the strip; the strip may be fastened and/or stitched adjacent to the fold to retain the airbag.

The present invention relates to a component for a vehicle interior configured to facilitate deployment of an airbag from an airbag module into a vehicle interior comprising a set of holder assemblies configured to contain the airbag; each holder assembly may comprise a wrapper configured to contain the airbag; the wrapper may comprise a strip and a tab; the strip may be configured to be wrapped around the airbag; the strip may be configured to provide a fold and a flap; the strip may be configured to provide the fold at a first location on the strip to provide a first position for retaining the airbag; the strip may be configured to provide the fold at a second location on the strip to provide a second position for retaining the airbag; the strip may be closed to retain the airbag; the holder assembly may comprise a package wrapper assembly and/or a wrapper package assembly and/or a package assembly and/or a holder assembly and/or a holder and/or a wrapper assembly and/or a wrapper and/or a package wrapper; the strip may be configured to provide the fold at the first location on the strip to provide a first form comprising the first position for retaining the airbag; the strip may be configured to provide the fold at the second location on the strip to provide a second form comprising the second position for retaining the airbag; the wrapper may be configured to retain the airbag in the first position to be opened at a seam in the strip and to be retained to the vehicle frame by the tab to direct a first trajectory of deployment of the airbag; the wrapper may be configured to retain the airbag in the second position to be opened at a seam in the strip and to be retained to the vehicle frame by the tab to direct a second trajectory of deployment of the airbag. The strip may be fixed and/or fastened to retain the airbag; the strip may be sealed and/or closed to retain the airbag; the strip may be closed by stitching to retain the airbag; the strip may be fixed by stitching to retain the airbag; the strip may be closed and fastened adjacent to the fold to retain the airbag; the strip may be secured by thread to retain the airbag; the strip may be sewn to retain the airbag; the strip may be stitched to retain the airbag; the strip may comprise a weakening line to facilitate tearing of the strip to facilitate deployment of the airbag. The tab may be secured on the strip and/or within the strip and/or to the strip; the tab may be stitched on the strip; the tab may be adhered to the strip; the tab may be secured to the strip adjacent to the fold of the strip; the tab may be secured on the strip and the airbag may be wrapped within the strip and secured within the strip. The airbag may be secured to the strip; the airbag may be rolled within the strip and secured within the strip; the airbag may be wrapped within the strip and secured within the strip; the airbag may comprise a generally cylindrical shape; the airbag may be rolled into a generally cylindrical shape; the strip may be configured to provide the fold at a third location on the strip to provide a third position for retaining the airbag. The holder assembly may be configured to be mounted to a vehicle frame in the vehicle interior; the holder assembly may be configured to form a tube-shaped holder. The vehicle interior may comprise a trim panel; the set of holder assemblies may be configured to be installed behind the trim panel. The vehicle interior may comprise a vehicle frame behind the trim panel. Each holder assembly of the set of holder assemblies may be configured to be attached to the vehicle frame behind the trim panel; each holder assembly of the set of holder assemblies may be configured to be attached to the vehicle frame by a set of fasteners; each holder assembly of the set of holder assemblies may be configured to be attached to the vehicle frame by a fastener at the tab and a fastener at the flap of the strip. Each fastener may comprise a pin or a bolt or a rivet or a plastic fastener. Each holder may be configured to direct formation of an opening for deployment of the airbag; each holder may be configured to direct formation of an opening in a trim panel for deployment of the airbag; each holder may be configured to retain the airbag in a position to direct deployment of the airbag; each holder may be configured to retain the airbag in a position to direct trajectory of deployment of the airbag; each holder may be configured to retain the airbag in a position to direct formation of an opening in the trim panel for deployment of the airbag. The trim panel may be configured to form an opening and/or a door for deployment of the airbag; the trim panel may comprise a seam configured to form a door for deployment of the airbag; the trim panel may be configured to provide a hinge for the door for deployment of the airbag; the trim panel may be configured to provide a tear line for the door for deployment of the airbag; the trim panel may be configured to provide a separation for the door for deployment of the airbag; the trim panel may be configured to provide an opening at the door for deployment of the airbag. Each holder assembly may be configured to provide a tear line at a seam in the strip for deployment of the airbag. The seam in the strip may comprise a perforation and/or a perforation line and/or a perforation and/or a slit and/or holes and/or cuts; the seam may comprise a perforation line in the strip wrapped around the airbag. Each holder assembly may comprise a seam for the tear line in the strip for deployment of the airbag. Each holder may be configured to be separated at the seam in the strip during deployment of the airbag and/or to be opened at the seam in the strip during deployment of the airbag and/or to be retained by the tab during deployment of the airbag and/or to be retained to the vehicle frame by the tab during deployment of the airbag and/or to be retained to the vehicle frame by the tab after deployment of the airbag; each holder may be configured to retain the airbag in a position to be opened at the seam in the strip and to be retained to the vehicle frame by the tab during deployment of the airbag; each holder may be configured to retain the airbag in a position to be opened at the seam in the strip and to be retained to the vehicle frame by the tab to route trajectory of deployment of the airbag; each holder may be configured to retain the airbag in a first position to be opened at the seam in the strip and to be retained to the vehicle frame by the tab to direct a first trajectory of deployment of the airbag; each holder may be configured to retain the airbag in a second position to be opened at the seam in the strip and to be retained to the vehicle frame by the tab to direct a second trajectory of deployment of the airbag; each holder may be configured to retain the airbag in a third position to be opened at the seam in the strip and to be retained to the vehicle frame by the tab to direct a third trajectory of deployment of the airbag; each holder may be configured to retain the airbag in a position to be opened at the seam in the strip and to be retained to the vehicle frame by the tab to direct a trajectory of deployment of the airbag to form a door providing an opening in a trim panel during deployment of the airbag; the position may comprise a plurality of selectable positions. The holder assembly may comprise a wrapper package assembly configured to retain an airbag in multiple positions; the holder assembly may comprise a wrapper package assembly configured to be adjustable by location of a stitch and/or a fold to provide multiple mounting positions within a range. The wrapper package assembly may be configured to retain and/or contain the airbag. The strip may be configured to be fixed to provide a form for the package wrapper when folded at the fold to provide the flap to be retained at the fold by a stitch at a location. The form may comprise a first form when the stitch is at a first location and a second form when the stitch is at a second location; the form may comprise a third form when the stitch is at a third location and a fourth form when the stitch is at a fourth location; the airbag may be wrapped into the form of the package wrapper to provide variable mounting positions for the airbag; the airbag may be wrapped into the form of the package wrapper to provide variable trajectories of deployment of the airbag. The strip may comprise a polypropylene material; the strip may comprise a die cut strip; the strip may comprise a sheet-formed strip configured to provide a plurality of mounting configurations in the vehicle interior. The package wrapper may comprise a base provided by the strip wrapped around the airbag to be mounted to a vehicle frame by fasteners. The fold and/or a fixing stitch for the strip can be provided at a first location and/or a second location and/or a third location; a fixing stitch for the strip can be provided at a first location and/or a second location and/or a third location; a fixing stitch for the strip can be attached at a fixed point on the strip defined by the fold; the stitch for the strip establishes the position of the airbag; the flap of the strip provides a mounting area for the package wrapper. An airbag assembly comprising the airbag may be configured to be contained by the strip wrapped around the airbag; the package wrapper may be formed by the strip wrapped around the airbag; the strip may comprise a plastic strip and/or an extruded strip and/or a flat-formed sheet and/or a molded sheet and or a sheet-formed cut strip; the strip may comprise a sheet-formed die-cut strip; the strip may comprise an aperture; the strip may comprise a weakened area configured to form a tear seam for an opening for deployment of the airbag. The airbag may comprise a rolled cushion pack; the package wrapper may be wrapped around the rolled cushion pack of the airbag. The component may comprise a plurality of package wrappers. The tab may comprise a fabric tab. Fastening on the strip may comprise an upper fastening to provide a form for the wrapper and a lower fastening to facilitate routing for trajectory of airbag deployment. A stitch on the strip may comprise an upper stitch to provide a form for the wrapper and a lower stitch to facilitate routing for trajectory of airbag deployment; the package wrapper may be stitched to the cushion of the airbag and stitched to enclose the cushion of the airbag within the strip of the package wrapper; the location of the stitch may determine the position of the airbag; the package wrapper may be formed by stitching the tab at the flap and the fold to close the strip into a form having a shape around the airbag. Slits may be provided on the strip to provide a seam providing a breakout location and direction of deployment for the airbag. Stitches for the package wrapper may be applied by needling through the strip. The strip may comprise a polypropylene material configured so that during deployment of the airbag the strip will break open to facilitate deployment of the airbag and the tab is retained intact.

The present invention relates to a component for a vehicle interior comprising a vehicle frame configured to facilitate deployment of an airbag from an airbag module into a vehicle interior comprising a set of package assemblies configured to contain the airbag; each assembly may comprise a wrapper configured to contain the airbag; each wrapper may comprise a strip and a tab; each strip may be configured to be wrapped around the airbag; each strip may be configured to provide a fold and a flap; each strip may comprise a seam configured to form an opening for deployment of the airbag; each strip may be closed to retain the airbag; each strip may be configured to provide the fold at a location on the strip to provide a position for retaining the airbag; the location for providing the fold may comprise a plurality of selectable locations; the position for retaining the airbag may comprise a plurality of selectable positions; each assembly may be configured to retain the airbag in the position to be opened at the seam in the strip and to be retained to the vehicle frame by the tab to direct a trajectory of deployment of the airbag to form a door providing an opening in a trim panel during deployment of the airbag. The position for retaining the airbag may comprise the plurality of selectable positions within a range. Each strip may be configured to provide the fold at a first location on the strip to provide a first position for retaining the airbag; each strip may be configured to provide the fold at a second location on the strip to provide a second position for retaining the airbag; the strip may be configured to provide the fold at the first location on the strip to provide a first form comprising the first position for retaining the airbag; the strip may be configured to provide the fold at the second location on the strip to provide a second form comprising the second position for retaining the airbag; the position may comprise a plurality of positions configured to be selected by location of the fold; the wrapper may be configured to retain the airbag in the first position to be opened at a seam in the strip and to be retained to the vehicle frame by the tab to direct a first trajectory of deployment of the airbag; the wrapper may be configured to retain the airbag in the second position to be opened at a seam in the strip and to be retained to the vehicle frame by the tab to direct a second trajectory of deployment of the airbag; the strip may be fixed and/or sealed and/or closed by stitching to retain the airbag.

The present invention relates to a component for a vehicle interior configured for deployment of an airbag into the vehicle interior comprising an airbag cushion assembly comprising a cushion and a tab and a package wrapper for the cushion; the package wrapper may comprise a wrap configured to enclose the airbag cushion; the package wrapper may comprise an extension extending from the wrap; the tab may be sewn to the cushion; the extension may comprise a flap; the wrap may comprise a strip; the tab may be sewn to the package wrapper; the tab may be sewn to the cushion and the package wrapper; the tab may comprise a mounting tab; the tab may be configured to couple the cushion to a frame of the vehicle; the package wrapper may comprise a unitary construction. The wrap of the package wrapper may extend around the cushion; the package wrapper may be coupled with the cushion; the wrap and the extension may be sewn to the cushion. The package wrapper may be folded to provide the wrap and the extension; the package wrapper may comprise a fold; the package wrapper may be sewn to the cushion at the fold and/or sewn to the tab at the fold. The component may comprise a rivet comprising a through hole configured to facilitate coupling of the cushion to a frame of the vehicle.

The present invention relates to a method of manufacturing a component for a vehicle interior configured for deployment of an airbag into the vehicle interior comprising the steps of providing a package wrapper, providing a cushion for the airbag, folding the package wrapper, coupling the package wrapper with the cushion, rolling the cushion, and closing the package wrapper around the cushion. The step of folding the package wrapper may comprise providing a wrap and an extension. The step of coupling the package wrapper with the cushion may comprise sewing the package wrapper to the cushion at the fold.

The present invention relates to a component for a vehicle interior configured to facilitate deployment of an airbag from an airbag module; the vehicle interior component may comprise a set of airbag package wrappers configured to be attached to the vehicle frame; each wrapper may be configured to contain the airbag; the wrapper may comprise a strip and a tab; the strip may be configured to be wrapped around the airbag; the strip may be configured to provide a fold and a tab secured to the strip; the strip may be configured to provide the fold at a first location on the strip to provide a first form comprising a first position for retaining the airbag; the strip may be configured to provide the fold at a second location on the strip to provide a second form comprising a second position for retaining the airbag; the strip may be closed to retain the airbag; the strip may comprise a seam configured to form a tear line for deployment of the airbag; the wrapper may be configured to retain the airbag in the first position to be opened at the seam in the strip and to be retained to the vehicle frame by the tab to direct a first trajectory of deployment of the airbag; the wrapper may be configured to retain the airbag in the second position to be opened at the seam in the strip and to be retained to the vehicle frame by the tab to direct a second trajectory of deployment of the airbag; the airbag may be rolled within the strip and secured within the strip; the strip may be closed adjacent to the fold to retain the airbag; the strip may be fixed adjacent to the fold to retain the airbag; the strip may be fixed by stitching to retain the airbag.

The present invention also relates to a component for a vehicle interior configured to facilitate deployment of an airbag from an airbag module into a vehicle interior; the vehicle interior component may comprise a set of holder assemblies configured to contain the airbag; each holder assembly may comprise a wrapper configured to contain the airbag; the wrapper may comprise a strip and a tab; the strip may be configured to be wrapped around the airbag; the strip may be configured to provide a fold and a tab; the strip may be configured to provide the fold at a first location on the strip to provide a first position for retaining the airbag; the strip may be configured to provide the fold at a second location on the strip to provide a second position for retaining the airbag; the strip may be closed to retain the airbag; the strip may be configured to provide the fold at the first location on the strip to provide a first form comprising the first position for retaining the airbag; the strip may be configured to provide the fold at the second location on the strip to provide a second form comprising the second position for retaining the airbag. The wrapper may be configured to retain the airbag in the first position to be opened at a seam in the strip and to be retained to the vehicle frame by the tab to direct a first trajectory of deployment of the airbag; the wrapper may be configured to retain the airbag in the second position to be opened at a seam in the strip and to be retained to the vehicle frame by the tab to direct a second trajectory of deployment of the airbag. The strip may be fixed to retain the airbag; the strip may be sealed to retain the airbag; the strip may be closed by stitching to retain the airbag; the strip may be fixed by stitching to retain the airbag; the strip may be closed adjacent to the fold to retain the airbag; the strip may be fixed adjacent to the fold to retain the airbag; the strip may be secured by thread to retain the airbag; the strip may be sewn to retain the airbag; the strip may be stitched to retain the airbag; the strip may comprise a weakening line to facilitate tearing of the strip to facilitate deployment of the airbag. The tab may be secured to the strip; the tab may be secured on the strip; the tab may be secured within the strip; the tab may be fastened to the strip; the tab may be stitched on the strip; the tab may be adhered to the strip; the tab may be secured to the strip adjacent to the fold of the strip; the fold of the strip may be made adjacent to where the tab may be secured to the strip; the tab may be secured on the strip and the airbag may be wrapped within the strip and secured within the strip. The airbag may be secured to the strip; the airbag may be secured within the strip; the airbag may be rolled within the strip and secured within the strip; the airbag may be wrapped within the strip and secured within the strip; the airbag may comprise a generally cylindrical shape; the airbag may comprise a generally tubular shape; the airbag may be rolled into a generally tubular shape; the airbag may be rolled into a generally cylindrical shape. The strip may be configured to provide the fold at a third location on the strip to provide a third position for retaining the airbag. The holder assembly may be configured to be mounted to a vehicle frame; the holder assembly may be configured to be mounted to a vehicle frame in the vehicle interior; the holder assembly may be configured to form a tube-shaped holder; the holder assembly may be configured to form a tube-shaped holder when the strip is folded to provide the fold and fixed to provide the flap. The vehicle interior may comprise a trim panel; a set of holder assemblies may be configured to be installed behind the trim panel; the vehicle interior may comprise a vehicle frame behind the trim panel; a set of holder assemblies may be configured to be installed to the vehicle frame; the set of holder assemblies may be configured to be installed to the vehicle frame behind the trim panel; the set of holder assemblies may be configured to be attached to the vehicle frame behind the trim panel; each holder assembly of the set of holder assemblies may be configured to be attached to the vehicle frame behind the trim panel; each holder assembly of the set of holder assemblies may be configured to be attached to the vehicle frame by a set of fasteners; each holder assembly of the set of holder assemblies may be configured to be attached to the vehicle frame by a pair of fasteners; each holder assembly of the set of holder assemblies may be configured to be attached to the vehicle frame by a fastener at the tab; each holder assembly of the set of holder assemblies may be configured to be attached to the vehicle frame by a fastener through an aperture at the tab; each holder assembly of the set of holder assemblies may be configured to be attached to the vehicle frame by a rivet at the tab; each holder assembly of the set of holder assemblies may be configured to be attached to the vehicle frame by a fastener at the flap of the strip; each holder assembly of the set of holder assemblies may be configured to be attached to the vehicle frame by a fastener through an aperture at the flap of the strip; each holder assembly of the set of holder assemblies may be configured to be attached to the vehicle frame by a bolt at the flap of the strip; each holder assembly of the set of holder assemblies may be configured to be attached to the vehicle frame by an expansion bolt at the flap of the strip; each holder assembly of the set of holder assemblies may be configured to be attached to the vehicle frame by a fastener at the tab and a fastener at the flap of the strip; each fastener may comprise a pin or a bolt or a rivet or a plastic fastener; each holder may be configured to direct formation of an opening for deployment of the airbag; each holder may be configured to direct formation of an opening in the trim panel for deployment of the airbag; each holder may be configured to retain the airbag in a position to direct deployment of the airbag; each holder may be configured to retain the airbag in a position to direct trajectory of deployment of the airbag; each holder may be configured to retain the airbag in a position to direct formation of an opening in the trim panel for deployment of the airbag. The trim panel may be configured to form an opening for deployment of the airbag; the trim panel may be configured to form a door for deployment of the airbag; the trim panel may comprise a seam configured to form a door for deployment of the airbag; the trim panel may be configured to provide a hinge for the door for deployment of the airbag; the trim panel may be configured to provide a tear line for the door for deployment of the airbag; the trim panel may be configured to provide a separation for the door for deployment of the airbag; the trim panel may be configured to provide an opening at the door for deployment of the airbag. Each holder assembly may be configured to provide a seam for deployment of the airbag; each holder assembly may be configured to provide a tear line for deployment of the airbag; each holder assembly may be configured to provide a tear line at a seam in the strip for deployment of the airbag; the seam may comprise a perforation; the seam may comprise a perforation line; the seam may comprise a perforation in the strip; the seam may comprise a line of perforations in the strip; the seam may comprise a perforation line in the strip wrapped around the airbag; each holder assembly may comprise a seam for the tear line in the strip for deployment of the airbag; each holder may be separated at the seam in the strip during deployment of the airbag; each holder may be opened at the seam in the strip during deployment of the airbag; each holder may be retained by the tab during deployment of the airbag; each holder may be retained to the vehicle frame by the tab during deployment of the airbag; each holder may be retained to the vehicle frame by the tab after deployment of the airbag; each holder may be opened at the seam in the strip and retained to the vehicle frame by the tab during deployment of the airbag; each holder may be configured to retain the airbag in a position to be opened at the seam in the strip and to be retained to the vehicle frame by the tab during deployment of the airbag; each holder may be configured to retain the airbag in a position to be opened at the seam in the strip and to be retained to the vehicle frame by the tab to direct trajectory of deployment of the airbag; each holder may be configured to retain the airbag in a first position to be opened at the seam in the strip and to be retained to the vehicle frame by the tab to direct a first trajectory of deployment of the airbag; each holder may be configured to retain the airbag in a second position to be opened at the seam in the strip and to be retained to the vehicle frame by the tab to direct a second trajectory of deployment of the airbag; each holder may be configured to retain the airbag in a third position to be opened at the seam in the strip and to be retained to the vehicle frame by the tab to direct a third trajectory of deployment of the airbag; each holder may be configured to retain the airbag in a position to be opened at the seam in the strip and to be retained to the vehicle frame by the tab to direct a trajectory of deployment of the airbag to form a door providing an opening in a trim panel during deployment of the airbag; the position may comprise a plurality of selectable positions; the holder assembly may comprise a package assembly; the holder assembly may comprise a wrapper package assembly; the holder assembly may comprise a wrapper package assembly configured to retain an airbag in multiple positions; the holder assembly may comprise a wrapper package assembly configured to be adjustable by location of a stitch and/or a fold to provide multiple mounting positions within a range; the wrapper package assembly may be configured to retain and/or contain the airbag; the holder assembly may comprise a package wrapper configured to contain the airbag and to be mounted to a vehicle frame; the holder assembly may comprise a package wrapper. The strip may be configured to provide a form when folded at the fold to provide the flap to be retained at the fold by a stitch; the strip may be configured to be fixed to provide a form for the package wrapper when folded at the fold to provide the flap to be retained at the fold by a stitch at a location; the form may comprise a first form when the stitch is at a first location and a second form when the stitch is at a second location; the form may comprise a third form when the stitch is at a third location and a fourth form when the stitch is at a fourth location. The airbag may be wrapped into the form of the package wrapper; the airbag may be wrapped into the form of the package wrapper to provide variable mounting positions for the airbag; the airbag may be wrapped into the form of the package wrapper to provide variable trajectories of deployment of the airbag. The strip may comprise a polypropylene strip; the strip may comprise a polypropylene material; the strip may comprise a die cut strip; the strip may comprise a sheet-formed strip configured to provide a plurality of mounting configurations in the vehicle interior. The package wrapper may comprise a base provided by the strip wrapped around the airbag to be mounted to a vehicle frame by fasteners. The fold and/or a fixing stitch for the strip can be provided at a first location and/or a second location and/or a third location; a fixing stitch for the strip can be provided at a first location and/or a second location and/or a third location; a fixing stitch for the strip can be attached at a fixed point on the strip defined by the fold. The airbag may be enclosed within the strip of the package wrapper. The stitch for the strip may establish the position of the airbag. The flap of the strip may provide a mounting area for the package wrapper. An airbag assembly may be configured to be contained by the strip wrapped around the airbag. The package wrapper may be formed by the strip wrapped around the airbag. The tab of the package wrapper may be retained to the vehicle frame by a fastener. The strip may comprise a plastic strip and/or an extruded strip and/or a flat-formed sheet and/or a molded sheet and or a sheet-formed cut strip; the strip may comprise a sheet-formed die-cut strip; the strip may comprise an aperture; the strip may be formed in a rotary tool; the strip may comprise an internal weakened area configured to form a tear seam for an opening for deployment of the airbag; the strip may comprise a hole for attachment. The airbag may comprise a rolled cushion pack. The package wrapper may be wrapped around the rolled cushion pack of the airbag. The component may comprise a plurality of package wrappers. The tab may comprise a fabric tab; the tab may comprise a mounting tab. The package wrapper may be stitched to the cushion of the airbag and then stitched to enclose the cushion of the airbag within the strip of the package wrapper; the location of the stitch may determine the position of the airbag; the package wrapper may be formed by stitching the tab at the flap and the fold to close the strip into a form having a shape around the airbag. Slits may be provided on the strip to provide a seam providing a breakout location and direction of deployment for the airbag. Stitches for the package wrapper may be applied by needling through the strip. The strip may comprise a polypropylene material configured so that during deployment of the airbag the strip will break open to facilitate deployment of the airbag and the tab is retained intact.

The present invention relates to a component for a vehicle interior configured to facilitate deployment of an airbag from an airbag module; the vehicle interior component may comprise a set of package assemblies configured to contain the airbag; each assembly may comprise a wrapper configured to contain the airbag; each wrapper may comprise a strip and a tab; each strip may be configured to be wrapped around the airbag; each strip may be configured to provide a fold and a tab; each strip may comprise a seam configured to form an opening for deployment of the airbag; each strip may be closed to retain the airbag; each strip may be configured to provide the fold at a location on the strip to provide a position for retaining the airbag; the location for providing the fold may comprise a plurality of selectable locations; the position for retaining the airbag may comprise a plurality of selectable positions. Each assembly may be configured to retain the airbag in the position to be opened at the seam in the strip and to be retained to the vehicle frame by the tab to direct a trajectory of deployment of the airbag to form a door providing an opening in a trim panel during deployment of the airbag; the position for retaining the airbag may comprise the plurality of selectable positions within a range; each strip may be configured to provide the fold at a first location on the strip to provide a first position for retaining the airbag; each strip may be configured to provide the fold at a second location on the strip to provide a second position for retaining the airbag; the strip may be configured to provide the fold at the first location on the strip to provide a first form comprising the first position for retaining the airbag; the strip may be configured to provide the fold at the second location on the strip to provide a second form comprising the second position for retaining the airbag; the position may comprise a plurality of positions configured to be selected by location of the fold. The wrapper may be configured to retain the airbag in the first position to be opened at a seam in the strip and to be retained to the vehicle frame by the tab to direct a first trajectory of deployment of the airbag; the wrapper may be configured to retain the airbag in the second position to be opened at a seam in the strip and to be retained to the vehicle frame by the tab to direct a second trajectory of deployment of the airbag. The strip may be fixed to retain the airbag; the strip may be sealed to retain the airbag; the strip may be closed by stitching to retain the airbag.

The present invention relates to a component for a vehicle interior configured for deployment of an airbag into the vehicle interior comprising an airbag cushion assembly comprising a cushion and a tab; and a package wrapper for the cushion. The package wrapper may comprise a wrap configured to enclose the airbag cushion. The package wrapper may comprise an extension extending from the wrap. The tab may be sewn to the cushion. The tab may be sewn to the package wrapper. The tab may be sewn to the cushion and the package wrapper. The tab may comprise a mounting tab. The tab may be configured to couple the cushion to a frame of the vehicle. The package wrapper may comprise a unitary construction. The wrap of the package wrapper may extend around the cushion. The package wrapper may be coupled with the cushion. The wrap and the extension may be sewn to the cushion. The package wrapper may be folded to provide the wrap and the extension. The package wrapper may comprise a fold; the package wrapper may be sewn to the cushion at the fold. The package wrapper may comprise a fold; the package wrapper may be sewn to the tab at the fold. The component may comprise a rivet comprising a through hole configured to facilitate coupling of the cushion to a frame of the vehicle. The component may comprise a trim panel. The component may comprise a headliner.

The present invention relates to a method of manufacturing a component for a vehicle interior configured for deployment of an airbag into the vehicle interior comprising providing a package wrapper; providing a cushion for the airbag; folding the package wrapper; coupling the package wrapper with the cushion; rolling the cushion; and closing the package wrapper around the cushion. The step of folding the package wrapper may comprise providing a wrap and an extension. The step of coupling the package wrapper with the cushion may comprise sewing the package wrapper to the cushion at the fold.

### Exemplary Embodiments—Y

According to an exemplary embodiment as shown schematically in the FIGURES, a component configured for deployment of an airbag into a vehicle interior may comprise an airbag cushion assembly comprising a cushion and a tab and a package wrapper for the cushion. The package wrapper may comprise a wrap to enclose the airbag cushion and an extension extending from the wrap. The tab may be sewn to the cushion and/or the package wrapper. The tab may couple the cushion to a frame of the vehicle. The package wrapper may comprise a unitary construction. The package wrapper may be folded to provide the wrap and the extension. The package wrapper may comprise a fold; the package wrapper may be sewn to the cushion at the fold; the package wrapper may be sewn to the tab at the fold. The component may comprise a trim panel. The component may comprise a headliner. A method of manufacturing the component is disclosed.

According to an exemplary embodiment as shown schematically in the FIGURES, a component configured to facilitate deployment of an airbag in a vehicle interior may comprise a set of package wrapper/holder assemblies configured to contain the airbag. Each wrapper/holder may comprise a strip configured to be wrapped around the airbag with a fold and a flap and a tab secured to the strip. The fold at a first location may provide a first form of the strip comprising a first position for the airbag. The fold at a second location may provide a second form of the strip comprising a second position for the airbag. The strip may be closed by stitching to retain the airbag. In the first position/form of the wrapper, the airbag may provide a first trajectory for airbag deployment. In the second position/form of the wrapper, the airbag may provide a second trajectory for airbag deployment. A method for producing the component is disclosed.

According to an exemplary embodiment as shown schematically in the FIGURES, a component configured to facilitate deployment of an airbag in a vehicle interior may comprise a set of package wrapper/holder assemblies configured to contain the airbag; each wrapper/holder comprises a strip configured to be wrapped around the airbag with a fold and a flap and a tab secured to the strip; the fold at a first location will provide a first form of the strip comprising a first position for the airbag; the fold at a second location will provide a second form of the strip comprising a second position for the airbag; the strip may be closed by stitching to retain the airbag; in the first position/form of the wrapper, the airbag provides a first trajectory for airbag deployment; in the second position/form of the wrapper, the airbag provides a second trajectory for airbag deployment. A method for producing the component is disclosed.

TABLE A
REFERENCE SYMBOL LIST

| REFERENCE | |
|---|---|
| SYMBOL | ELEMENT |
| V | VEHICLE |
| VI | VEHICLE INTERIOR |
| VF | VEHICLE/INTERIOR FRAME |
| C | COMPONENT |
| SZ | SEAT |
| PN | PANEL (TRIM PANEL) |
| AB | AIRBAG/ASSEMBLY |
| ABM | AIRBAG MODULE |
| ABD | AIRBAG DOOR |
| | (OF TRIM PANEL) |
| ABK | AIRBAG PACKAGE/HOLDER |
| | (WRAPPER/ASSEMBLY) |
| STR | STRIP (WRAP/STRAP) |
| STRf | FLAP OF STRIP/WRAP |
| STRd | FOLD OF STRIP/WRAP |
| TB | TAB |
| SH | STITCH |
| FS | FASTENER |
| BR | BRACKET |
| HG | HINGE/HINGE AREA |
| RS | SEAM/RECESS (PERFORATION/ |
| | TEAR LINE) (TRIM PANEL) |
| TR | SEAM/RECESS (PERFORATION/ |
| | TEAR LINE) (STRIP/WRAP OF |
| | WRAPPER/PACKAGE) |
| X/Y/Z | POSITION (AIRBAG RETENTION) |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A component for a vehicle interior comprising a vehicle frame configured to facilitate deployment of an airbag from an airbag module into a vehicle interior comprising:
a set of package assemblies configured to contain the airbag;
wherein each assembly of the set of package assemblies comprises a wrapper configured to contain the airbag;
wherein each wrapper comprises a strip;
wherein each strip is configured to be wrapped around the airbag;
wherein each strip is configured to provide a fold and a flap;
wherein each strip comprises a seam configured to form an opening for deployment of the airbag;
wherein each strip is closed to retain the airbag;
wherein each strip is configured to provide the fold at a location on the strip to provide a position for retaining the airbag;
wherein the location for providing the fold comprises a plurality of selectable locations;
wherein the position for retaining the airbag comprises a plurality of selectable positions;
wherein each assembly is configured to retain the airbag in the position to direct deployment of the airbag.

2. The component of claim 1 wherein each wrapper comprises the strip and a tab; wherein each assembly is configured to be retained to the vehicle frame by the tab to direct the trajectory of deployment of the airbag during deployment of the airbag.

3. The component of claim 1 wherein the component is configured to be installed in a trim panel in the vehicle interior; wherein each assembly is configured to retain the airbag to be opened at the seam in the strip to direct deployment of the airbag to form an opening in the trim panel during deployment of the airbag.

4. The component of claim 1 wherein the airbag is rolled within the strip and secured within the strip of the wrapper of the set of package assemblies.

5. The component of claim 1 wherein the strip is fastened adjacent to the fold to retain the airbag and/or the strip is stitched adjacent to the fold to retain the airbag.

6. The component of claim 1 wherein the strip is configured to be fixed to provide a form for the wrapper when folded at the fold and to provide a flap to be retained at the fold by a stitch at a location.

7. The component of claim 6 wherein the flap of the strip provides a mounting area for the wrapper; wherein the wrapper is configured to provide selectable mounting positions for the airbag and/or to provide selectable trajectories of deployment of the airbag.

8. The component of claim 1 wherein a stitch on the strip comprises an upper stitch to provide a form for the wrapper and a lower stitch to facilitate routing for trajectory of deployment of the airbag.

9. The component of claim 1 wherein fastening on the strip comprises an upper fastening to provide a form for the wrapper and a lower fastening to facilitate routing for trajectory of airbag deployment.

10. The component of claim 1 wherein the wrapper comprises a package wrapper; wherein the package wrapper is stitched to a cushion of the airbag and stitched to enclose the cushion of the airbag within the strip of the package wrapper.

11. The component of claim 10 wherein the package wrapper is formed by stitching the tab at the flap and the fold to close the strip into a form having a shape around the airbag.

12. The component of claim 1 wherein slits are provided on the strip to provide the seam providing a breakout location for direction of deployment for the airbag.

13. The component of claim 1 wherein the seam comprises a weakened area configured to form a tear seam for an opening for deployment of the airbag.

14. The component of claim 2 wherein the strip comprises a polypropylene material configured so that during deployment of the airbag the strip will break open to facilitate deployment of the airbag and the tab is retained intact.

15. The component of claim 1 wherein a fixing stitch for the strip is attached at a fixed point on the strip defined by the fold; wherein the fixing stitch establishes the position of the airbag.

16. The component of claim 1 wherein the wrapper is configured to retain the airbag in a first position to be opened at the seam in the strip and to be retained to the vehicle frame by the tab to direct a first trajectory of deployment of the airbag; wherein the wrapper is configured to retain the airbag in a second position to be opened at the seam in the strip and to be retained to the vehicle frame by the tab to direct a second trajectory of deployment of the airbag.

17. A component for a vehicle interior comprising a vehicle frame configured to facilitate deployment of an airbag from an airbag module comprising:
a set of package wrappers configured to be attached to the vehicle frame;
wherein a wrapper of the set of package wrappers is configured to contain the airbag;
wherein the wrapper comprises a strip and a tab;
wherein the strip is configured to be wrapped around the airbag;
wherein the strip is configured to provide a fold;
wherein the strip is configured to provide the fold at a first location on the strip to provide a first form comprising a first position for retaining the airbag;
wherein the strip is configured to provide the fold at a second location on the strip to provide a second form comprising a second position for retaining the airbag;
wherein the strip is closed to retain the airbag;
wherein the strip comprises a seam configured to form a tear line for deployment of the airbag;
wherein the wrapper is configured to retain the airbag in the first position to be opened at the seam in the strip and to be retained to the vehicle frame by the tab to direct a first trajectory of deployment of the airbag;
wherein the wrapper is configured to retain the airbag in the second position to be opened at the seam in the strip and to be retained to the vehicle frame by the tab to direct a second trajectory of deployment of the airbag.
wherein the set of package wrappers is configured to be adjustable by location of a stitch and/or the fold to provide multiple mounting positions for each wrapper.

18. The component of claim 17 further comprising a set of package assemblies comprising the set of package wrappers; wherein each assembly of the set of package assemblies comprises a holder assembly for each wrapper of the set of package wrappers; wherein each holder assembly is configured to be adjustable by location of a stitch and/or the fold to provide multiple selectable mounting positions for each wrapper within a range.

19. The component of claim 18 wherein the holder assembly is configured to be attached to the vehicle frame by a fastener at the tab and/or a fastener at the flap of the strip.

20. The component of claim 17 wherein fastening on the strip comprises an upper fastening to provide a form for the wrapper and a lower fastening to facilitate routing for trajectory of airbag deployment.
